(19) United States
(12) Patent Application Publication
(10) Pub. No.: US 2009/0292896 A1
(43) Pub. Date: Nov. 26, 2009

(54) INFORMATION MANAGEMENT METHOD, RECORDING/PLAYBACK APPARATUS, AND INFORMATION STORAGE MEDIUM

(76) Inventors: Hideo Ando, Hino-shi (JP); Hisashi Yamada, Yokohama-shi (JP); Masafumi Tamura, Chofu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/369,894

(22) Filed: Feb. 12, 2009

(30) Foreign Application Priority Data
May 23, 2008 (JP) 2008-135760

(51) Int. Cl. G06F 12/02

(52) U.S. Cl. 711/170; 711/E12.002

(57) ABSTRACT

In an information management method according to an embodiment of the invention, one or more freely installable memory cards are used. A suitable information management can be made even if a part or all of the memory cards is/are optionally attached or detached. Digital AV information of which recording may be distributed over the one or more memory cards is managed according to a prescribed format (which is common to all of the memory cards). Identification information for identifying the card is recorded on each of the memory cards. Allocation information (FAT) indicating where is allocated a portion of the digital AV information is also recorded on each of the memory cards. The allocation information of each of the memory cards identified by the identification information is acquired, and the acquired allocation information is integrated. The acquisition and integration are performed each time the memory card is attached or detached.

### CROSS-REFERENCE TO RELATED APPLICATIONS

This application is based upon and claims the benefit of priority from Japanese Patent Application No. 2008-135760, filed May 23, 2008, the entire contents of which are incorporated herein by reference.

### BACKGROUND

1. Field

One embodiment of the present invention relates to a digital information management method and a digital information recording/playback apparatus, which use one or more information storage media (memory cards and the like).

2. Description of the Related Art

In recent years, along with the prevalence of digital TV broadcasting or high-speed Internet lines, the distribution quantities of digital movie information (AV information) are increasing, and various media for recording such information have been developed. As typical examples of such media, optical discs using red or blue lasers and hard disc drives (HDDs) are available. Along with the recent capacity enhancement and cost reduction of semiconductor flash memories, the semiconductor memories emerge as major candidates for AV information recording media. However, at present, each individual memory capacity does not suffice to save large-size digital moving image information, and only when a large number of memories are used together, they can be used as an AV information bank like a large-capacity HDD. Hence, a demand has arisen for a system using a large number of memories for AV information. A system that uses a plurality of memories for the purpose of recording of image data is conventionally available (see Jpn. Pat. Appln. KOKAI Publication No. 2006-133898).

Jpn. Pat. Appln. KOKAI Publication No. 2006-133898 discloses a data recording apparatus which distributes and records received image information in a plurality of memory cards, and allows easy data management of distributed and recorded image information by classifying them.

However, in the apparatus disclosed in Jpn. Pat. Appln. KOKAI Publication No. 2006-133898, in a situation that a large number of memory cards are used to record long-term digital moving image information, information management upon randomly inserting and removing (attaching and detaching) the memory cards is insufficient.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram for explaining a home network system according to one embodiment of the invention;

FIG. 2 is an exemplary view for explaining a hierarchical structure in an enhanced HDMI communication;

FIG. 3 is an exemplary view for explaining the internal arrangement of an information storage medium (memory card) according to one embodiment of the invention;

FIG. 4 is an exemplary view for explaining the internal arrangement of an information storage medium (memory card) according to another embodiment of the invention;

FIG. 5 is an exemplary view for explaining an example of a memory reservoir shelf (memory card bank) according to one embodiment of the invention;

FIG. 6 is an exemplary view for explaining another example of a memory reservoir shelf (memory card bank) according to one embodiment of the invention;

FIG. 7 is an exemplary view for explaining a memory reservoir shelf (USB memory card bank) according to another embodiment of the invention;

FIG. 8 is an exemplary view for explaining a memory reservoir shelf (memory card bank having a storage unit like a microwave oven) according to still another embodiment of the invention;

FIG. 9 is an exemplary block diagram for explaining an example of a control unit of the memory reservoir shelf (memory card bank);

FIG. 10 is an exemplary flowchart for explaining an example of the sequence for searching for and merging free areas of one or more memory cards attached to or loaded in the memory reservoir shelf (memory card bank);

FIG. 11 is an exemplary flowchart for explaining an example of the sequence for recording information on one or more memory cards attached to or loaded in the memory reservoir shelf (memory card bank);

FIG. 12 is an exemplary flowchart for explaining an example of the sequence for video-recording AV information (single program) in one or more memory cards attached to or loaded in the memory reservoir shelf (memory card bank);

FIG. 13 is an exemplary flowchart for explaining an example of the sequence for playing back AV information (single program) video-recorded in one or more memory cards attached to or loaded in the memory reservoir shelf (memory card bank);

FIG. 14 is an exemplary flowchart for explaining an example of the sequence for editing (partially erasing) AV information video-recorded in one or more memory cards attached to or loaded in the memory reservoir shelf;

FIG. 15 is an exemplary flowchart for explaining an example of the sequence for reconstructing management information when AV information video-recorded in one or more memory cards attached to or loaded in the memory reservoir shelf (memory card bank) has been changed (partially erased or moved);

FIG. 16 is an exemplary view showing the volume structure for data areas of one or more memory cards attached to or loaded in the memory reservoir shelf (memory card bank);

FIG. 17 is an exemplary view showing the layout of a system area in the volume structure;

FIG. 18 is an exemplary view showing data fields which include a master boot record and a plurality of partition tables included in a partition area in the volume structure;

FIG. 19 is an exemplary view showing internal fields of each partition table;

FIG. 20 is an exemplary view showing internal fields of a file directory entry field;

FIG. 21 is an exemplary view showing the recording format in an information storage medium according to one embodiment of the invention;

FIG. 22 is an exemplary view showing the contents of general information included in video object information and stream object information;

FIG. 23 is an exemplary view showing the contents of time map information included in the video object information and stream object information;

FIG. 24 is an exemplary view showing the contents of program chain information for video recording, which is to undergo presentation time-based management, and the contents of program chain information for stream recording, which is to undergo presentation time-based management; and

FIG. 25 is an exemplary view showing the file structure in an information storage medium according to one embodiment of the invention.

### DETAILED DESCRIPTION

Various embodiments according to the invention will be described hereinafter with reference to the accompanying drawings. In general, according to one embodiment of the invention, digital information (AV information or the like) that can be distributed and recorded on one or more information storage media is managed according to a predetermined format (a format common to all information storage media which are uniformly managed). With this information management method, identification information that specifies each information storage medium is recorded in that medium, and allocation information indicating the allocation of a part of the digital information is recorded in each information storage medium.

With this method, pieces of allocation information of the one or more information storage media identified by pieces of corresponding identification information are collected, and the pieces of collected allocation information are merged. That is, when the number of one or more information storage media is increased, pieces of allocation information are collected respectively from the one or more information storage media, the number of which is increased, and the pieces of collected allocation information are merged. On the other hand, when some of the one or more information storage media are physically or logically removed, pieces of allocation information are collected from the remaining information storage media after some media are removed, and the pieces of collected allocation information are merged. As described above, information collection and merging can be done as needed every time the number of information storage media used is increased or decreased (every time an information storage medium is attached or detached).

In this manner, even when some of one or more expandable information storage media are arbitrarily attached or detached, appropriate information management is allowed.

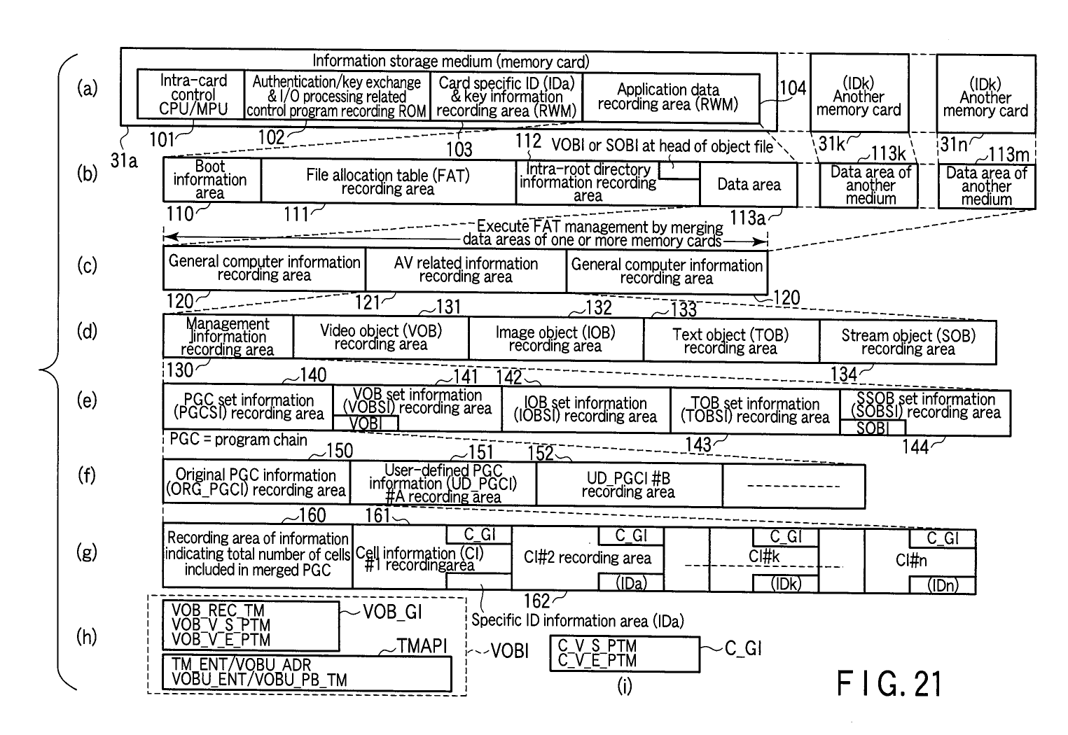

Various embodiments of the invention will be described hereinafter with reference to the drawings. An information storage medium according to one embodiment of the invention can be configured by various types of information storage media or information storage devices. As a typical information storage medium, a nonvolatile semiconductor memory such as a flash memory or the like is available. Independently of the types of information storage media to be adopted, in the data structure adopted in an information storage medium according to the embodiment of the invention, each of one or more information storage media (for example, memory cards 31a to 31n in FIG. 21) can be configured to adopt some or all of the following items.

(1) Object files are divided in correspondence with data objects to be recorded (MPEG-2 PS video objects VOB or MPEG-2 TS or MPEG-4 AVC (H.264) TSE stream objects SOB).

(2) The same contents (or the contents including common principal fields) of object management information (VOBI or SOBI which records information including the recording start times and the like of objects, time map information indicating correspondence between the recording positions of objects and their playback times, and so forth) are recorded at a plurality of locations (for example, at the following two locations):

(2.1) one location (for example, in a recording area of a file system): the management information is allocated at the head of a corresponding object file (a logically corresponding object file on file allocation table FAT); and

(2.2) the other location (for example, in a VOBSI or SOBSI recording area): pieces of VOBI or SOBI associated with all VOB or SOB object files recorded in a single information storage medium (memory card or the like) are recorded together as a single VOBI management file or SOBI management file in a single information storage medium (memory card or the like).

(3) Playback management information (PGCI used to manage the playback order of cells as playback units) is recorded for each information storage medium (memory card or the like) (in this case, cells are divided in correspondence with different information storage media, i.e., a single cell is inhibited from being recorded in different information storage media).

(4) Identification information of an information storage medium (memory card or the like) and/or VOB or SOB identification information in a single information storage medium (memory card or the like) are/is recorded in cell information (CI). Note that the identification information of an information storage medium (memory card or the like) includes ID information of the information storage medium (memory card or the like), or a unique VOBI management file name or a unique SOBI management file name for each information storage medium (memory card or the like). Also, the VOB or SOB identification information in a single information storage medium (memory card or the like) includes VOB or SOB identification information or an object file name specified in a VOBI management file or SOBI management file.

(5) Objects (VOB or SOB) with the related recorded contents (the contents of a single program or the like), which are recorded in different information storage media (memory cards or the like) are allowed to be played back (more specifically, the playback order of recorded objects is defined by ORG_PGCI for each information storage medium. After object recording, the playback order that the user wants is defined as needed by UD_PGCI for each information recording medium).

(6) Each information storage medium (memory card or the like) is connected in a plug-and-play manner to a system (recording/playback apparatus, a home server of AV information, or the like) which uses the medium.

FIG. 21 is a view for explaining the recording format (data structure) in information storage medium (to be represented by a nonvolatile memory card such as a flash memory or the like hereinafter) 31 according to the embodiment of the invention. The information storage medium in FIG. 21 is normally embodied in the form of a memory card, and has, for example, a card shape of a stick gum size or stamp size. Although not shown, this memory card comprises, at a predetermined external position, electrodes used to establish connection (that for information exchange and energy supply) to an external device, light-emitting and light-receiving elements (using visible light or invisible light such as infrared rays or the like) used to establish connection to an external device, or an electromagnetic wave (electric wave) antenna used to establish connection to an external device. The memory card main body can be configured by a semiconductor IC prepared by building a microcomputer and its peripheral devices as needed onto a nonvolatile memory (flash memory) of, e.g., 256 MB to 16 GB (a capacity larger than 16 GB in the future). FIG. 21 shows the contents of some of a plurality of memory cards 31a to 31n, and each memory card includes a common structure. However, individual memory cards have different unique card specific IDs (or unique names). The internal structure of memory card 31a will be explained as a representative below.

As shown in (a) of FIG. 21, memory card 31a has a copy protection function, and can prevent any illicit copy or illicit use for information recorded in the memory card. That is, with respect to an external device (an information playback apparatus, information recording/playback apparatus, digital TV, home server, or the like),

(a) the memory card itself uniquely performs mutual authentication and encryption key exchange,

(b) it exchanges encrypted information, and

(c) only a partner device (an information playback apparatus, information recording/playback apparatus, digital TV, home server, or the like) which is authenticated by the memory card can use normal information (after decryption).

Control CPU (MPU) 101 in the memory card executes encryption/decryption of information and information input/output interface processing commencing with such mutual authentication processing and encryption key exchange. A program (firmware) that makes control CPU 101 in the memory card operate is stored in ROM 102 used to record authentication/key exchange & I/O processing related control programs. The partner device authenticated by the memory card performs authentication and identification for each individual memory card to make security management of information which is transferred and input to each card.

As a means for guaranteeing information management for each card, which is to be executed by the partner device authenticated by the memory card, the memory card has an ID specific to itself, and can set a specific encryption key. That is, a specific ID (the manufacturer name, product name, lot number, serial number, and the like of that card) assigned to each individual memory card and specific encryption key information (information of Advanced Access Control System: AACS, etc.) are recorded in card specific ID & key information recording area (Read-Write Memory: RWM) 103. A card name (that can be freely assigned by the user via a remote-controller operation or the like) unique to each individual card can be stored in this recording area 103.

Memory card 31a with the copy protection function has application data recording area (Read-Write Memory: RWM) 104 in addition to the aforementioned area, and can record, in this RWM 104, AV information (video object VOB or stream object SOB), still image information (image object IOB), text information (text object TOB), management information (PGCSI, VOBSI, IOBSI, TOBSI, SOBSI) used to manage these pieces of information, and the like of a digital TV broadcasting program, Internet-delivered video content, or the like.

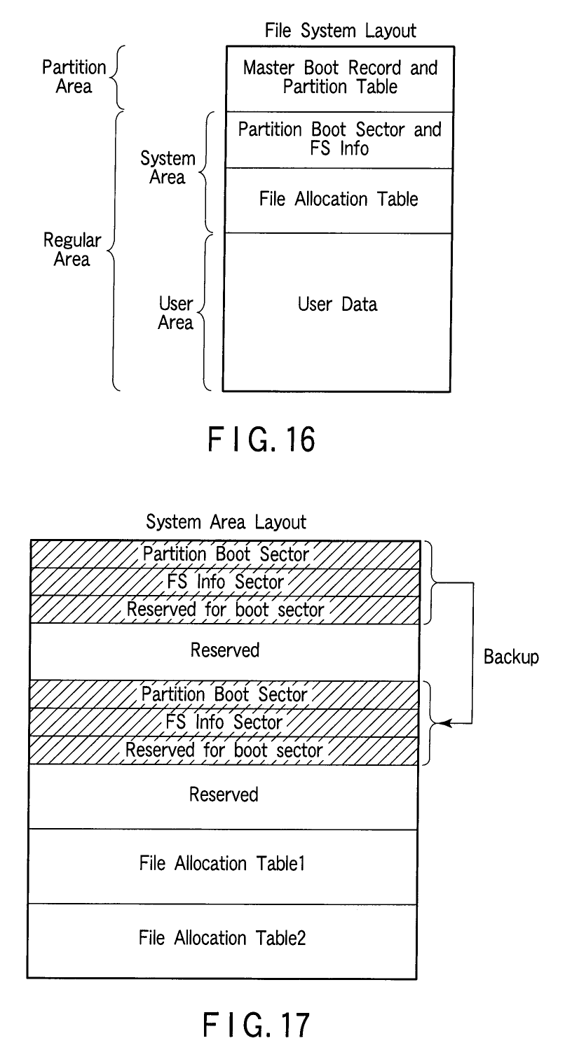

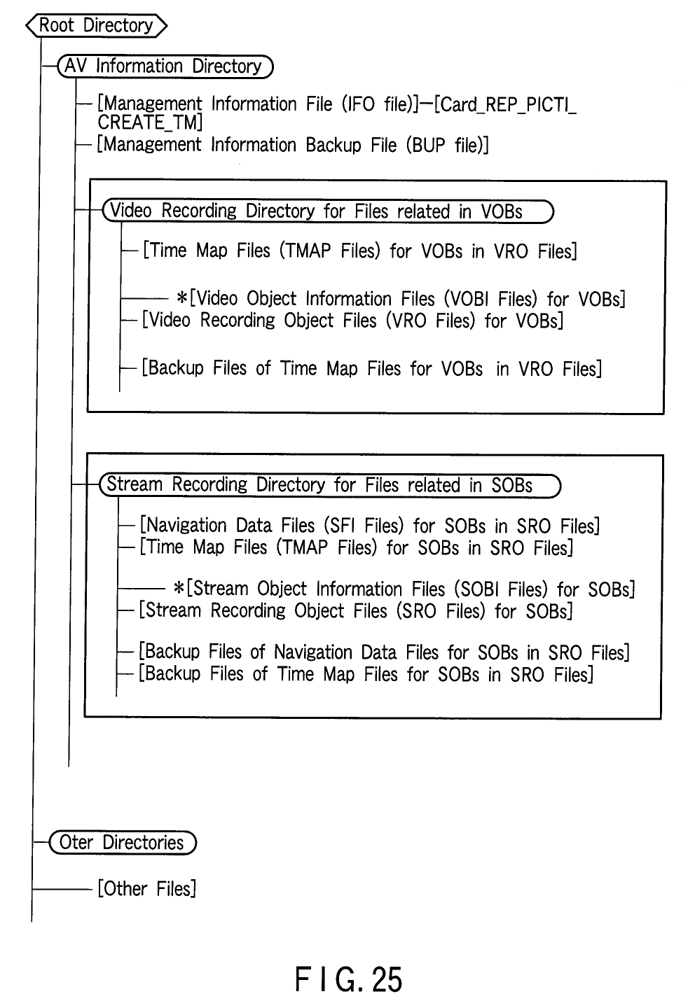

As shown in (b) of FIG. 21, this application data recording area (RWM) 104 includes boot information recording area 110, file allocation table (FAT) recording area 111, intra-root directory information recording area 112, and data area 113. As the file format of data recorded in application data recording area 104, the FAT format is adopted. This FAT can have a volume structure including a file system layout shown in, e.g., FIGS. 16 to 20. Management information files, object data files, and the like recorded in data area 113 are managed using a hierarchical structure, as shown in FIG. 25. This hierarchical structure file information is stored in intra-root directory information recording area 112.

When the memory card shown in FIG. 21 is connected to an external device such as an information recording/playback apparatus or the like, the system of this information recording/playback apparatus reads information recorded in boot information recording area 110, and automatically boots (starts up) (the memory card which is added to the system after the system boots up serves as a plug-and-play device). After that, when this information recording/playback apparatus plays back desired AV information from the memory card, it reads file allocation information in FAT recording area 111 to detect the storage address of the desired information, and accesses the contents of application data recording area 104 based on this address.

Data area 113a of memory card 31a can arbitrarily include AV related information recording area 121 and one or more general computer information recording areas 120 together. The same applies to other memory cards 31k and 31n. Data areas 113a to 113n of a plurality of memory cards under the management of the FAT of these memory cards 31a to 31n are merged and managed together. As a result, a logical data area has a structure including AV related information recording area 121 and one or more general computer information recording areas 120 together by merging the data areas of a plurality of memory cards, as shown in (c) of FIG. 21.

If 256 memory cards having a 16 GB size are merged, a huge memory bank of a total of 4 TB is formed, and can record and save a large number of high-definition digital TV broadcasting programs (for a long period of time). Even upon starting with only a single 16 GB memory card, when the user buys further up to 64 memory cards, the total memory capacity amounts to 1 TB. When the number of memory cards reaches 256, the total memory capacity amounts to 4 TB. Hence, the bought memory cards can be efficiently used. A redundant memory card can be re-used for a personal computer and the like. When a redundant memory card in a personal computer or other devices is manufactured under the standard common to the memory card shown in FIG. 21, it can be used to expand the memory bank in the apparatus according to the embodiment of the invention.

Furthermore, since memory cards of different capacities (normally having different retail prices) of the arbitrary numbers can be used together, the user can buy and use cards of desired capacities within a purchase range for his or her money as he or she wants (for example, in one purchase method, the user may buy one 16 GB card and two 4 GB cards, and may additionally buy several inexpensive cards of 256 MB to 1 GB if he or she has more money). That is, since many memory cards of arbitrary capacities can be used in a plug-and-play manner (within the upper limit that can be accepted by the system), the consumer demands of memory cards are enhanced, and the bought memory cards can be efficiently used.

As shown in (d) of FIG. 21, AV related information recording area 121 can include image object (IOB) recording area 132, text object (TOB) recording area 133, stream object (SOB) recording area 134, and the like in addition to management information recording area 130 and video object (VOB) recording area 131. AV information recorded in the memory card is stored in VOB recording area 131 and/or SOB recording area 134, still image information recorded in the memory card is stored in IOB recording area 132, and text information recorded in the memory card is stored in TOB recording area 133.

Although not shown in (d) of FIG. 21, an audio-dedicated audio object (AOB) recording area may be allocated in AV related information recording area 121 in (c) of FIG. 21. Net-delivered music information or the like may be recorded in video object recording area 131 together with appropriate image information, but such music information can be recorded in the audio-dedicated audio object (AOB) recording area (not shown).

Management information recording area 130 is divided into recording areas, as shown in (e) of FIG. 21. That is, management information recording area 130 includes program chain set information (PGCSI) recording area 140, video object set information (VOBSI) recording area 141, image object set information (IOBSI) recording area 142, text object set information (TOBSI) recording area 143, stream object set information (SOBSI) recording area 144, and the like.

As shown in (f) of FIG. 21, PGCSI recording area 140 includes original PGC information (ORG_PGCI) recording area 150 which stores original program chain information, and one or more user-defined PGC information (UD_PGCI) recording areas 151, 152, . . . which store information of program chains that are newly defined by the user during use of the memory card.

More specifically, management information (ORG_PGCI, UD_PGCI) which manages the playback order of playback units (cells) and the like in association with recorded AV information (VOB or SOB) is included in PGC set information PGCSI. The PGCSI can include at least one original program chain information (ORG_PGCI) and one or more pieces of user-defined program chain information (UD_PGCI) as needed. In some cases, no UD_PGCI may be stored. Each individual PGCI (ORG_PGCI or UD_PGCI) is information indicating the playback order of programs as logical units of a recorded content. A chain of one or more programs corresponds to program chain PGC. Playback of this PGC as a whole is described using the playback order of cells defined in the PGCI.

Management information (VOB_GI) that manages a recording start time (VOB_REC_TM), playback start time (VOB_V_S_PTM), playback end time (VOB_V_E_PTM), and the like of a VOB is stored in VOBI ((c) and (h) of FIG. 21) included in VOB set information VOBSI. (VOBSI can include one or more pieces of VOBI.) Time map information TMAPI used to convert playback times (VOBU_PB_TM) in a VOB into the addresses (VOBU_ADR) of corresponding recorded object units (VOBUs) in association with the recorded VOB is also stored in VOBI ((h) of FIG. 21) included in the VOBSI.

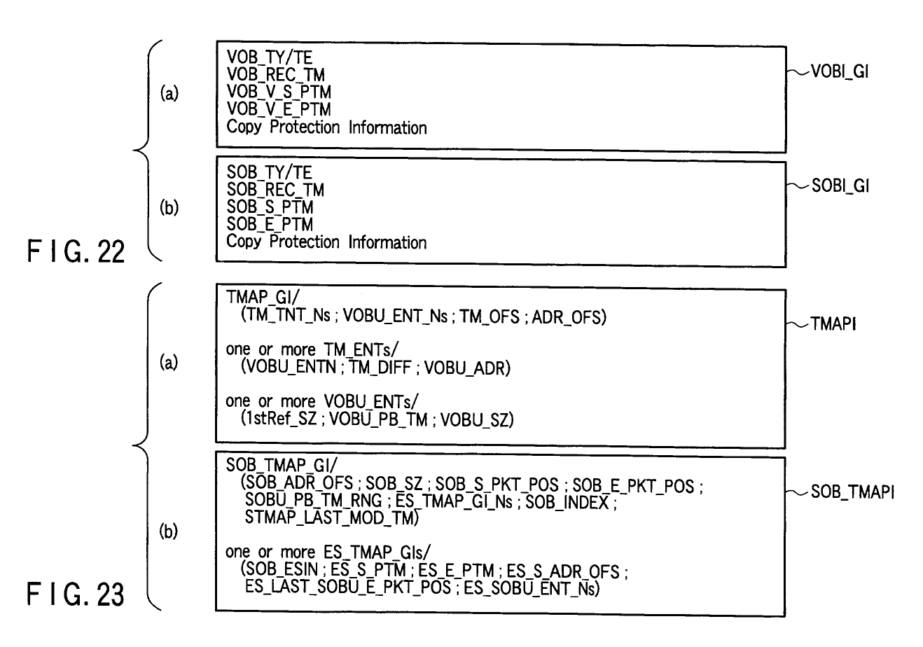

Likewise, management information (SOBI_GI in (b) of FIG. 22) that manages a recording start time (SOB_REC_TM), playback start time (SOB_V_S_PTM), playback end time (SOB_V_E_PTM), and the like of an SOB is stored in SOBI ((e) of FIG. 21) included in SOB set information SOBSI. (SOBSI can include one or more pieces of SOBI.)

The contents of the VOBI (or SOBI) are recorded not only in the VOBSI (or SOBSI) in (e) of FIG. 21 but also at the head of object files corresponding to that VOBI (or SOBI), as exemplified in files with “*” in FIG. 25. (Information in the file structure shown in FIG. 25 can be stored in intra-root directory information recording area 112 in (b) of FIG. 21.)

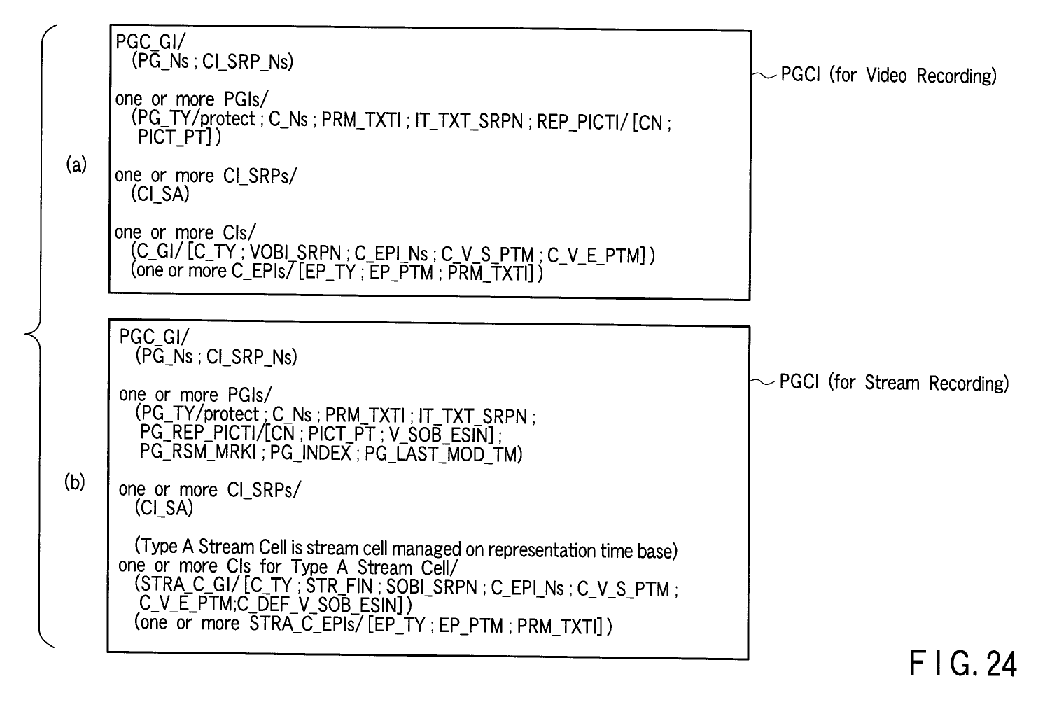

ORG_PGC information recording area 150 includes recording area 160 of information (corresponding to C_Ns in PGI in (a) and (b) of FIG. 24) indicating the total number of cells (information units which configure an original PGC) included in that PGC, and one or more cell information (CI) recording areas 161, 162, . . . , as shown in (g) of FIG. 21. Each UD_PGC information recording area also includes similar cell information (CI) recording areas.

One or more cell information (CI) recording areas included in the ORG_PGC information recording area or UD_PGC information recording area respectively have areas for recording memory card specific IDs and areas for recording cell general information C_GI. Cell general information C_GI stores video start time information C_V_S_PTM and video end time information C_V_E_PTM of that cell, as shown in (i) of FIG. 21.

For example, when data areas 113a, 113k, and 113n of memory cards 31a, 31k, and 31n are merged, IDa as a card specific ID of memory card 31a (or unique VOBI management file name a or unique SOBI management file name a* of that memory card) is recorded in specific ID recording areas of two pieces of cell information CI#1 and CI#2 for objects recorded in memory card 31a. Also, IDk as a card specific ID of memory card 31k (or unique VOBI management file name k or unique SOBI management file name k* of that memory card) is recorded in a specific ID recording area of cell information CI#k for an object recorded in memory card 31k. Furthermore, IDn as a card specific ID of memory card 31n (or unique VOBI management file name n or unique SOBI management file name n* of that memory card) is recorded in a specific ID recording area of cell information CI#n for an object recorded in memory card 31n.

In this manner, the card specific ID (or the unique VOBI management file name or unique SOBI management file name of each memory card) recorded in the specific ID information area in each cell information (CI) allows to specify the memory card that records a certain recorded object to which a playback unit (cell) belongs.

In this example, when a recorded object (recorded content) corresponding to cell information (e.g., CI#2) in a given memory card and a recorded object (recorded content) corresponding to cell information (e.g., CI#k) of another memory card are separately stored, management that can prevent playback units (cells) of an identical content from being stored in a plurality of memory cards can be executed. With this management, even when some of the plurality of memory cards whose recording data are merged are physically or logically removed, no problem is posed in playback of the recorded content of the remaining memory cards.

For example, assume that the data areas of memory cards 31a, 31k, and 31n are merged, and objects (AV information) corresponding to playback units C#1, C#2, C#k, and C#n managed by four pieces of cell information CI#1, CI#2, CI#k, and CI#n are recorded on the merged data area. When all the memory cards are active, the recorded objects are played back in the order of, e.g., C#1→C#2→C#k→C#n in accordance with the description of the management information (corresponding PGCI in PGCSI). In this case, when, for example, memory card 31k is removed, three pieces of cell information CI#1, CI#2, and CI#n remain as those to be managed by the management information (PGCI). Then, the recorded objects after memory card 31k is removed are played back in the order of C#1→C#2→C#n according to the description of the management information (PGCI). In this case, the recorded object corresponding to cell information CI#k is excluded from playback, but the recorded objects in remaining memory cards 31a and 31n are normally played back.

However, if the recorded object corresponding to cell C#k is recorded in remaining memory card 31a and removed memory card 31k, it becomes impossible to play back a part of the recorded object corresponding to cell C#k recorded in remaining memory card 31a. For example, assuming that cells C#1, C#2, C#k, and C#n respectively correspond to objects of the first, second, k-th, and n-th stories of a TV broadcasting drama, if the object of the k-th story is recorded in two memory cards, and one (memory card 31k) of these memory cards is removed, the k-th story in the remaining memory card (memory card 31a) may have a missing starting part or may be left unfinished. If the playback unit (cell) of an identical content is prevented from being recorded in a plurality of memory cards, for example, even when the k-th story is entirely cut after removal of a given memory card, playback of the k-th story can be prevented from missing a starting part or being left unfinished (if the user wants to watch the k-th story, he or she need only connect memory card 31k to the playback system again). In this example, an information list indicating the relationship between the stories of the video-recorded drama and the memory cards that record those stories can be stored in, e.g., VOB files or SOB files of the target drama of object files in “Video Recording Directory for Files related in VOBS” or “Stream Recording Directory for Files related in SOBs” in FIG. 25, although not shown.

In memory card 31a with the aforementioned data structure, a recorded content is stored at corresponding locations in recording areas 131 to 134 in (d) of FIG. 21. Also, management information after the user has edited (erased or moved) the stored recorded content is stored at a corresponding location in recording area 130 in (d) of FIG. 21. (For example, when the user has edited object SOB that stream-records a digital TV broadcasting program, management information SOBI after editing is stored in area 144 in (e) of FIG. 21.)

In the embodiment of the invention, as memory cards 31a to 31n with the copy protection function shown in FIG. 21, those which record AV information and the like protected from any illicit copy/illicit use are mainly assumed. However, memory cards 31a to 31n in FIG. 21 can be used to record not only AV information but also application files (or PC data) of a wordprocessor, spreadsheet, and the like used in general personal computer PC (reference numeral 120 in (c) of FIG. 21 denotes a recording area for those files).

In this case, by using the authentication/key exchange & I/O processing related control programs stored in ROM 102 in (a) of FIG. 21 and the card specific ID and key information stored in RWM 103 as needed, any illicit copy/illicit use of application files (or PC data) of the wordprocessor, spreadsheet, game, and the like can be avoided. That is, memory cards 31a to 31n shown in FIG. 21 can be used not only as blank media freely used by the user in recording/playback, but also as one or a set of a plurality of package media used to distribute a computer program (application program, game program, etc.) to be protected from any illicit copy/illicit use.

FIG. 22 shows an example of the contents of general information (VOB_GI and SOBI_GI) included in video object information and stream object information. This VOB_GI includes VOB_TY indicating a type of corresponding video object VOB, VOB_REC_TM indicating a time upon recording of start video data of the corresponding VOB, VOB_V_S_PTM indicating the playback start time of a first video field of the corresponding VOB, VOB_V_E_PTM indicating the playback end time of the last video field of the corresponding VOB, and copy protection information. The VOB_TY includes a flag (TE) indicating whether or not the corresponding VOB is in a temporarily erased state. The temporarily erased state can be canceled later, but a cell in a user-defined PGC never refers to a VOB in the temporarily erased state.

Likewise, SOBI_GI includes SOB_TY indicating a type of corresponding stream object SOB, SOB_REC_TM indicating a time upon recording of start video data of the corresponding SOB, SOB_S_PTM indicating the playback start time of a first video field (or video frame) of the corresponding SOB, SOB_E_PTM indicating the playback end time of the last video field (or video frame) of the corresponding SOB, and copy protection information. The SOB_TY includes a flag (TE) indicating whether or not the corresponding SOB is in a temporarily erased state. The temporarily erased state can be canceled later, but a cell in a user-defined PGC never refers to an SOB in the temporarily erased state.

FIG. 23 shows an example of the contents of time map information (TMAPI and SOB_TMAPI) included in video object information and stream object information. This TMAPI includes time map general information TMAP_GI, one or more time entries TM_ENT, and one or more VOBU entries VOBU_ENT (a VOBU corresponds to a basic unit of a VOB, and includes one or more GOPs). The TMAP_GI includes TM_TNT_Ns indicating the number of time entries, VOBU_ENT_Ns indicating the number of VOBU entries, TM_OFS indicating a time offset of the TMAPI, and ADR_OFS indicating the start address of the corresponding VOB.

Each of the one or more time entries includes number VOBU_ENTN of a VOBU entry, TM_DIFF indicating a time difference between the playback start time of a VOBU designated by that time entry and a separately calculated playback time, and VOBU_ADR indicating the address of the first pack of data packs which configure the corresponding VOBU. Each of the one or more VOBU entries includes 1stRef_SZ indicating the size of a reference picture (I picture or the like) which belongs to the corresponding VOBU, VOBU_PB_TM indicating the playback time of that VOBU, and VOBU_SZ indicating the size of that VOBU.

On the other hand, the SOB_TMAPI includes SOB time map general information SOB_TMAP_GI, and one or more pieces of elementary stream time map general information ES_TMAP_GI. Note that the SOB_TMAP_GI includes SOB_ADR_OFS indicating the start address of a corresponding SOB, SOB_SZ indicating the size of that SOB, SOB_S_PKT_POS indicating the start packet position of data packets included in that SOB, SOB_E_PKT_POS indicating the end packet position of data packets included in that SOB, SOBU_PB_TM_RNG indicating the playback time range of an SOBU as a basic unit of that SOB, ES_TMAP_GI_Ns indicating the number of pieces of ES_TMAP_GI, SOB_INDEX indicating an index number of that SOB, and STMAP_LAST_MOD_TM indicating the last modification time of the contents of a time map file of that SOB.

Each ES_TMAP_GI includes SOB_ESIN indicating a number of information SOB_ESI of a video elementary stream for which a time map is generated, ES_S_PTM indicating the playback start time of a first video field (or frame) of that elementary stream, ES_E_PTM indicating the playback start time of the last video field (or frame) of that elementary stream, ES_S_ADR_OFS indicating the start address of that elementary stream, ES_LAST_SOBU_E_PKT_POS indicating the end packet position in the last SOBU in a corresponding SOB, and ES_SOBU_ENT_Ns indicating the number of SOBU entries in elementary time map information.

Principal parts of FIGS. 22 and 23 will be briefly summarized below. That is, the VOBI includes the VOB_GI and TMAPI, which store VOB/VOBU time information and position information. The SOBI includes the SOBI_GI and SOB_TMAPI, which store SOB/SOBU time information and position information.

FIG. 24 is a view showing the contents of program chain information for video recording, which is to undergo presentation time-based management, and the contents of program chain information (PGCI) for stream recording, which is to undergo presentation time-based management. FIG. 24 shows PGCI for video recording, which is to undergo time-based playback management, and PGCI for stream recording of type A, which is to undergo time-based playback management.

The PGCI for video recording includes PGC general information PGC_GI, one or more pieces of program information PGI, one or more cell information search pointers CI_SRPs, and one or more pieces of cell information CI. The PGC_GI includes PG_Ns indicating the number of programs, and CI_SRP_Ns indicating the number of cell information search pointers. Each PGI includes program type PG_TY including a protect bit that indicates the protection state of a program, the number C_Ns of cells in that program, primary text information PRM_TXTI used in that program, item text search pointer number IT_TXT_SRPN used to search for item text corresponding to that program, and information REP_PICTI of a representative picture (thumbnail picture, etc.) corresponding to that program. This REP_PICTI includes number CN of a cell including a picture used as the representative picture, and PICI_PT indicating a representative picture point in that cell.

Each CI_SRP includes start address CI_SA of corresponding cell information. Each cell information CI includes cell general information C_GI and one or more pieces of cell entry point information C_EPI. The C_GI includes cell type C_TY indicating a type of the corresponding cell (e.g., that of a movie), VOBI search pointer number VOBI_SRPN, C_EPI_Ns indicating the number of pieces of C_EPI, video start time C_V_S_PTM of that cell, and video end time C_V_E_PTM of that cell. Each C_EPI can include primary text information PRM_TXTI as needed, in addition to EP_TY indicating a type of a corresponding entry point, and EP_PTM indicating the playback time of that entry point.

Likewise, the PGCI for stream recording (type A of presentation time base) includes PGI general information PGC_GI, one or more pieces of program information PGI, one or more cell information search pointers CI_SRPs, and one or more pieces of cell information CI. The PGC_GI includes PG_Ns indicating the number of programs, and CI_SRP_Ns indicating the number of cell information search pointers. Each PGI includes program type PG_TY including a protect bit that indicates the protection state of a program, the number C_Ns of cells in that program, primary text information PRM_TXTI used in that program, item text search pointer number IT_TXT_SRPN used to search for item text corresponding to that program, information PG_REP_PICTI of a representative picture (thumbnail picture, etc.) corresponding to that program, resume marker information PG_RSM_MRKI of that program, index PG_INDEX of that program, and last modification time PG_LAT_MOD_TM of that program. Note that the PG_REP_PICTI includes number CN of a cell including a picture used as the representative picture, PICI_PT indicating a representative picture point in that cell, and V_SOB_ESIN indicating an SOB_ESI number of a video elementary stream for the representative picture (when the representative picture is included in a stream cell of type A).

Each CI_SRP includes start address CI_SA of corresponding cell information. Cell information CI for a stream cell of presentation time base (type A) includes cell general information STRA_C_GI, and one or more pieces of cell entry point information STRA_C_EPI. The STRA_C_GI includes cell type C_TY indicating a type of the corresponding cell (e.g., that of a movie), stream file information number STR_FIN, SOBI search pointer number SOBI_SRPN, C_EPI_Ns indicating the number of pieces of STRA_C_EPI, playback start time C_V_S_PTM of that cell, playback end time C_V_E_PTM of that cell, and number C_DEF_V_SOB_ESIN of a video elementary stream to be played back as a default in that cell. Each C_EPI can include primary text information PRM_TXTI as needed, in addition to EP_TY indicating a type of that entry point, and EP_PTM indicating the playback time of that entry point.

FIG. 25 is a view showing an example of the file structure in the information storage medium (to be represented by a memory card hereinafter) according to the embodiment of the invention. Information of this file structure can be stored in, e.g., intra-root directory information recording area 112 in (b) of FIG. 21. Management information (navigation data) for the whole memory card is stored in a management information file and its backup file under an AV information directory. This management information file can record management information in (e) to (i) of FIG. 21. Each video object VOB recorded in the memory card is recorded under a video recording directory for files related in VOBs, and each stream object SOB is recorded under a stream recording directory for files related in SOBs. Other kinds of information are stored in independent files under other directories.

The video recording directory includes VOB time map files (TMAP files) and their backup files, and VOB object files (VRO files), and also includes video object information files (VOBI files) obtained by copying information (time information, time map information, and the like of recorded VOBs) of the VOBI at the head of the respective VRO files (see recording area 112 in (b) of FIG. 21).

The stream recording directory includes SOB navigation data files (stream file information files) and their backup files, SOB time map files (TMAP files) and their backup files, and SOB object files (SRO files), and also includes stream object information files (SOBI files) obtained by copying information (time information, time map information, and the like of recorded SOBs) of SOBI at the head of the respective SRO files (see recording area 112 in (b) of FIG. 21).

Note that the management information file in FIG. 25 can record representative picture information (Card_REP_PICTI) of each individual memory card. This Card_REP_PICTI includes information (which uses, e.g., information of program chain number PGCN, and indicates the presence of the card representative picture by PGCN=0) indicating the presence/absence of the representative picture of that memory card, information (PGN) indicating a number of a program including the card representative picture, information (CN) indicating a number of a cell including the card representative picture, information (PICI_PT) indicating the representative picture point in that cell, and information (Card_REP_PICTI_CREATE_TM) indicating the creation time of the card representative picture. This Card_REP_PICTI_CREATE_TM indicates the time when the representative picture of the corresponding memory card was created. The Card_REP_PICTI_CREATE_TM may be fixed at the time when the card representative picture was created first. When the card representative picture created first was modified once or more later, the Card_REP_PICTI_CREATE_TM may indicate its last modification time.

When a large number of memory cards currently incorporated in the system are sorted in the order of Card_REP_PICTI_CREATE_TM, thumbnail pictures of the memory cards can be sorted and displayed in that order. That is, as information used to sort a large number of memory cards, the Card_REP_PICTI_CREATE_TM can be used in addition to the specific IDs unique to the respective memory cards, or card names (text) given to the respective memory cards by the user.

FIG. 16 is a view showing an example of the volume structure for respective data areas of one or more memory cards attached to or loaded in a memory reservoir shelf (memory card bank). A file system layout in this volume structure includes a partition area and regular area. The partition area includes a master boot record and partition table. The regular area includes a system area and user area. The system area includes a partition boot sector and FS info (file system information), and a file allocation table (FAT), and the user area stores user data.

Although not shown, the partition boot sector describes a medium identifier, physical disc number, volume ID number, FAT entry value, and the like. This FAT entry value describes a value indicating a corresponding cluster which has already been allocated. The FAT entry value can also include a description as to whether or not the last cluster of a corresponding file has already been allocated.

FIG. 17 is a view showing an example of the layout of the system area in the volume structure. The system area includes a partition boot sector, FS info sector, reserved boot sector, and their backup sectors. The file allocation table (FAT) includes one or more file allocation tables.

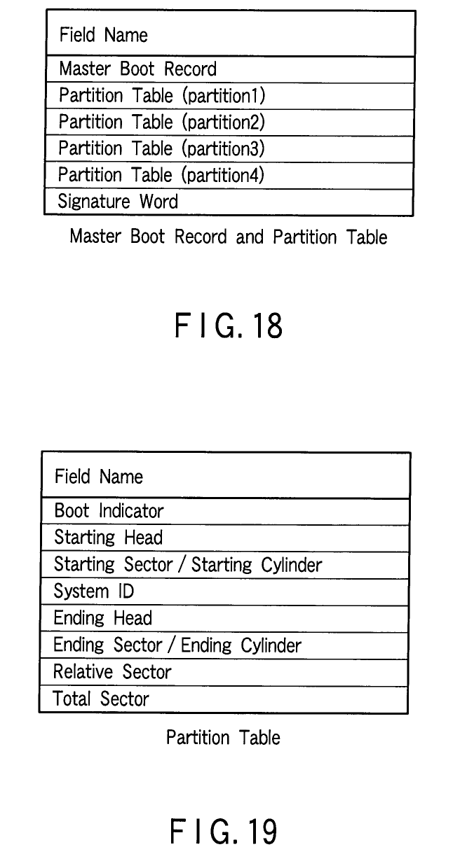

FIG. 18 is a view showing an example of data fields including a master boot record and a plurality of partition tables included in the partition area in the volume structure. The master boot record is a recording area which can be freely used by the system, and can record VOBI or SOBI information (information including the recording start times of objects and the like, time map information indicating the correspondence between the object recording positions and their playback times, and the like). The partition tables are assured in correspondence with one or more partitions, and the user can access respective partitions without any mutual authentication processing. Signatures for these master boot record and partition tables can be stored in a signature word area as needed.

FIG. 19 is a view showing an example of internal fields of each partition table. This partition table includes a boot indicator field, starting head field, starting sector/starting cylinder field, system ID field, ending head field, ending sector/ending cylinder field, relative sector field, and total sector field.

The boot indicator field describes a code indicating whether or not a corresponding memory card is used in system booting. If the boot indicator fields of respective memory cards describe that the corresponding memory cards are used in system booting, system booting can be automatically done even when any of these memory cards are connected to the system. If there are memory cards that allow system booting, the first memory card recognized by the system executes booting.

The starting head field indicates the starting head of a corresponding partition. The starting sector/starting cylinder field indicates the starting sector and starting cylinder of the corresponding partition.

The system ID field describes a code indicating whether or not the end position of the corresponding partition is smaller than predetermined bytes (e.g., 0.8 GB to 1 GB).

The ending head field indicates the ending head of the corresponding partition. The ending sector/ending cylinder field indicates the ending sector and ending cylinder of the corresponding partition.

The relative sector field describes the number of sectors which exist before the starting sector of the corresponding partition. The total sector field describes the total number of sectors of the corresponding partition.

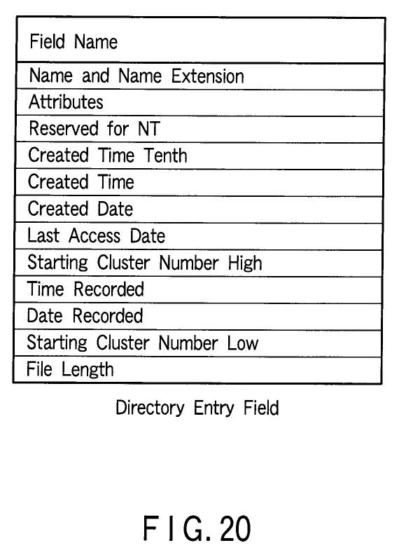

FIG. 20 is a view showing internal fields of a file directory entry field. This directory entry field includes a name and name extension field, attribute field, reserved for NT field, created time tenth field, created time field, created date field, last access date field, starting cluster number high field, time recorded field, date recorded field, starting cluster number low field, and file length field.

The name and name extension field describes a character code indicating the name of a corresponding file, or a character code indicating the name of a subdirectory described by an entry including a corresponding field.

The attribute field describes attribute information of each entry. This attribute information can include information that inhibits a modification of a corresponding file, information that excludes the corresponding file or corresponding subdirectory from a display target, information indicating that a corresponding entry includes a volume label, information indicating that the corresponding entry is a directory, information which is set at the time of creation of the corresponding file, and indicates that the characteristics of the corresponding file have been modified, and the like.

The reserved for NT field is reversed for future use. The created time tenth field describes a file creation time in units of 1/10 sec. The created time field describes a file creation time. The created date field describes a file creation date. The last access date field describes the last access date when a last read/write operation to a file or directory described by a corresponding entry is defined as a last access.

The starting cluster number high field describes an upper word of the first data cluster number for the file or directory indicated by the corresponding entry. The starting cluster number low field describes a lower word of the first data cluster number for the file or directory indicated by the corresponding entry.

The time recorded field describes the last modification (write) time. Immediately after creation of the file, this time recorded field describes the same value as the created time field. The date recorded field describes the last modification (write) date. Immediately after creation of the file, this date recorded field describes the same value as the created date field. The file length field describes the data size included in the file or directory indicated by the corresponding entry.

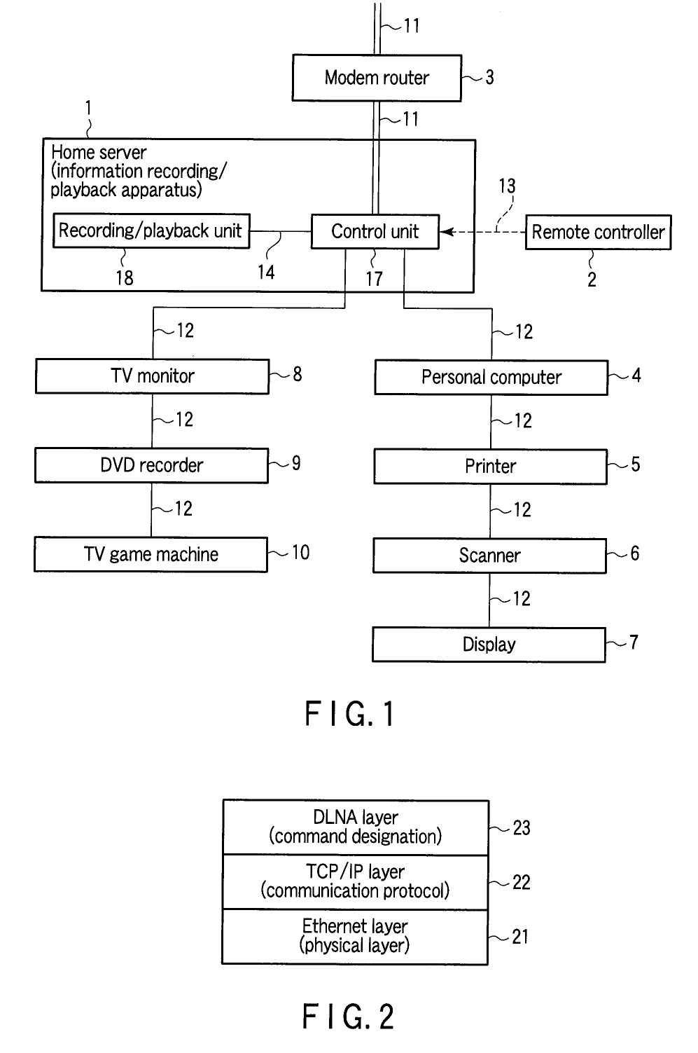

FIG. 1 shows a home network system which uses a home server or information recording/playback apparatus according to the embodiment of the invention. Various kinds of information such as movie information, audio information, and the like are delivered to each home via optical cable 11. Various kinds of information delivered into each home via optical cable 11 are relayed by modem router 3, are then transferred to home server (or information recording/playback apparatus) 1 according to the embodiment of the invention, and are finally recorded and saved in information storage medium (memory card or the like) 31. In order to allow high-speed transfer of information between home server (or information recording/playback apparatus) 1 and modem router 3, home server (or information recording/playback apparatus) 1 and modem router 3 are also connected via optical cable 11. Note that home server (or information recording/playback apparatus) 1 can simultaneously mount a plurality of information storage media 31. This is a large characteristic feature of this embodiment. Various kinds of information such as movie information, audio information, and the like transferred via modem router 3 are distributed and recorded in the plurality of information storage media 31, thus achieving a large recording capacity in home server 1.

As will be described later, this home server (or information recording/playback apparatus) 1 includes recording/playback unit 18 to which the plurality of information storage media 31 are attached, and its control unit 17. Recording/playback unit 18 can increase the maximum recordable capacity in home server 18 by expansion. To control unit 17, optical cable 11 connected to modem router 3 and EHDMI (Enhanced High Definition Multimedia Interface) cable 12 can be directly connected, and control unit 17 executes transfer control of various kinds of information, and operation control of all devices connected to the home network system. (This operation control is mainly based on operations of remote controller 2 by the user.) This control unit 17 and recording/playback unit 18 are connected via special dedicated cable 14 so as to allow high-speed transfer of various kinds of information. However, the invention is not limited to such specific cable, and these units may be connected via USB (Universal Serial Bus).

This home server (or information recording/playback apparatus) 1 and TV monitor 8 are connected via aforementioned EHDMI cable 12, and a list of various kinds of information (thumbnails of recorded information and the like) which are distributed and recorded in the plurality of information storage media 31 can be displayed on TV monitor 8. When the user designates information he or she wants to watch based on the display result using remote controller 2, home server 1 receives designated information at remote controller 2 via infrared rays 13. Home server 1 displays information played back from information storage media 31 that record the designated information on TV monitor 8.

In the embodiment shown in FIG. 1, home digital devices such as DVD recorder 9, TV game machine 10, personal computer 4, printer 5, scanner 6, display 7, and the like are connected via identical EHDMI cables 12. As a result, based on designation at remote controller 2 by the user, various kinds of information saved in home server (or information recording/playback apparatus) 1, and those saved in personal computer 4 and DVD recorder 9 can be moved and copied with each other.

Note that, although not shown, TV monitor 8 and DVD recorder 9 incorporate a terrestrial digital broadcasting tuner and/or satellite digital broadcasting tuner, and can also exchange digital broadcasting streams (MPEG-TS) with home server 1.

FIG. 2 is a view for explaining the hierarchical structure in an enhanced HDMI communication. “EHDMI (Enhanced High Definition Multimedia Interface)” shown in FIG. 1 indicates HDMI (High Definition Multimedia Interface) with an Ethernet™ function, and has a hierarchical structure at the time of information transfer, as shown in FIG. 2. That is, physical Ethernet layer 21 is set as the lowermost layer, and TCP/IP layer 22 indicating a communication protocol is defined on layer 21. Various devices connected via EHDMI cables 12 can implement transfer processing of various kinds of information or control processing for other devices by issuing various commands defined in DLNA (Digital Link Network Assistant) layer 23 on layer 22.

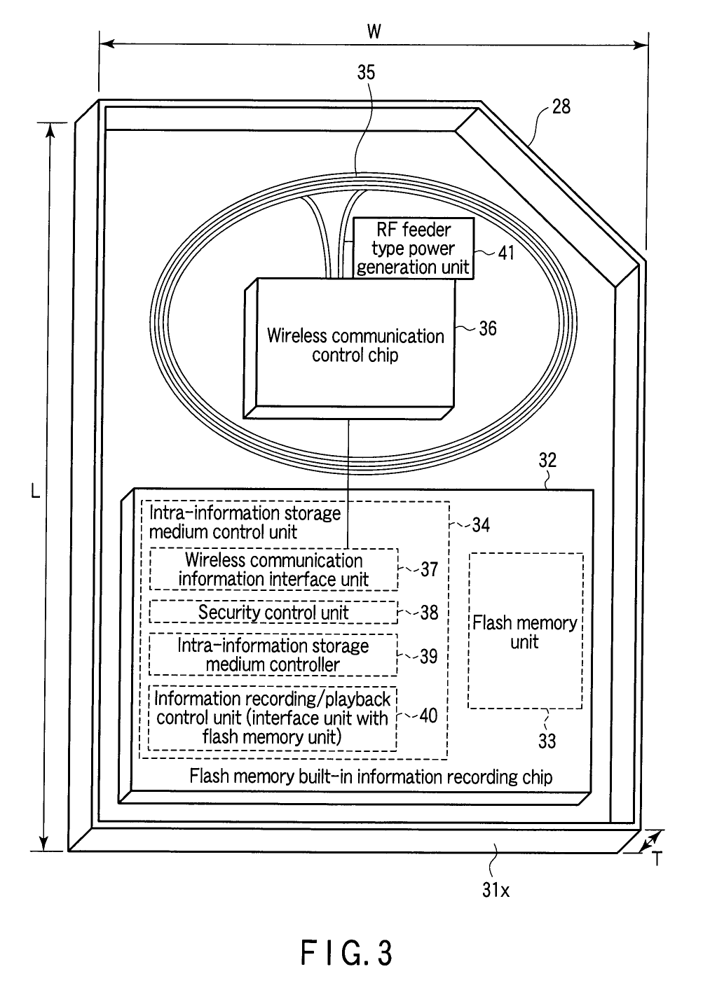

FIG. 3 is a view showing an example of the structure in information storage medium (memory card) 31x which is detachably attached in aforementioned recording/playback unit 18 and can record and play back information. An outer shape is a low-profile rectangular parallelepiped shape which has width W, length L, and thickness T, and partially has notched part 28. Information recording chip 32 which incorporates, e.g., a NAND type flash memory is arranged inside information storage medium 31x, and flash memory unit 33 in chip 32 records various kinds of information. The remaining part of information recording chip 32 has a monolithic structure in which intra-information storage medium control unit 34 is arranged.

This intra-information storage medium control unit 34 includes information recording/playback control unit 40 which controls recording and playback of various kinds of information in flash memory unit 33, and sets the recording location in flash memory unit 33, thus configuring an interface unit with flash memory unit 33. This intra-information storage medium control unit 34 also includes intra-information storage medium controller 39 which controls integrated operations in information storage medium 31, and security control unit 38 which prevents any illicit copy and illicit leakage of various kinds of information recorded in flash memory unit 33.

In the embodiment shown in FIG. 3, transfer processing of various kinds of information with information storage medium 31 is executed using wireless communications. For this purpose, wireless communication antenna 35 and wireless communication control chip 36 are also incorporated. At the same time, RF feeder type power generation unit 41 generates electric power from electromagnetic wave energy of radio transmission received by wireless communication antenna 35, and supplies electric power to wireless communication control chip 36 and flash memory built-in information recording chip 32. Furthermore, wireless communication information interface unit 37 included in intra-information storage medium control unit 34 is directly electrically connected to wireless communication control chip 36, and executes transmission control of information to be output toward recording/playback unit 18 and reception control of information sent from recording/playback unit 18.

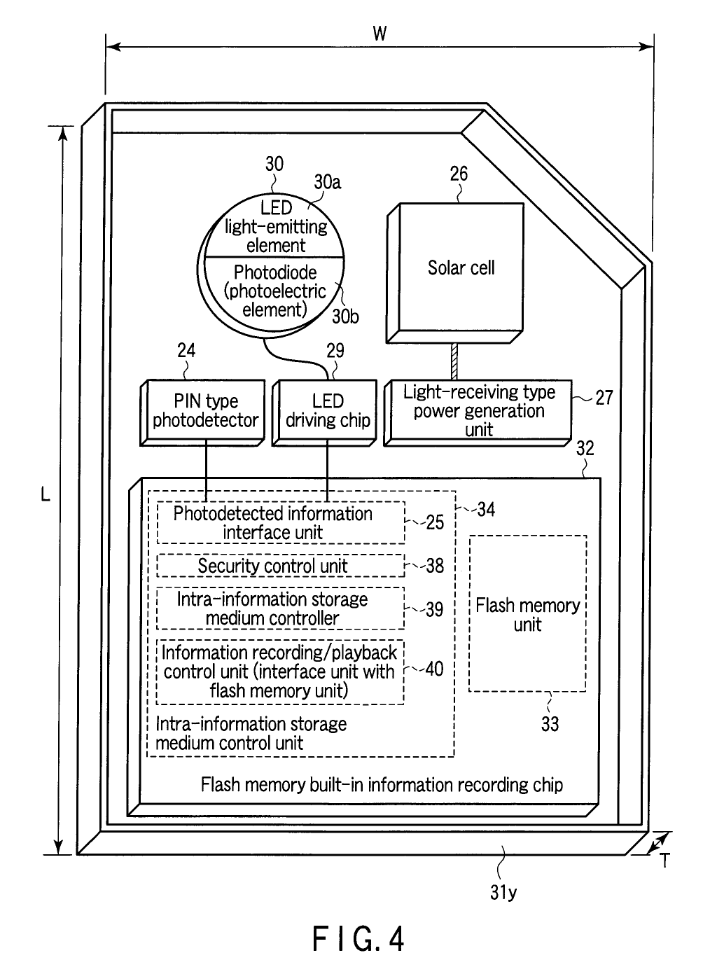

FIG. 4 is a view for explaining the internal arrangement of information storage medium (memory card) 31y according to another embodiment of the invention. In FIG. 3, transfer processing of various kinds of information (and energy transfer) with recording/playback unit 18 is attained by wireless communications. However, in the embodiment shown in FIG. 4, transfer processing of various kinds of information (and energy transfer) uses visible light or invisible light such as infrared rays. Since high-speed information transfer is demanded between information storage medium 31y and recording/playback unit 18, PIN type photodetector 24 is used to optically receive various kinds of information, and signals of various kinds of information, which are photoelectrically converted by photodetector 24, are transferred to photodetected information interface unit 25. Upon outputting information recorded in advance in flash memory unit 33 to recording/playback unit 18 in home server (or information recording/playback apparatus) 1, photodetected information interface unit 25 drives LED driving chip 29 to output signals of various kinds of information by blinking of LED light-emitting element 30.

Electric power supplied to respective chips in this information storage medium 31y is supplied as optical energy from recording/playback unit 18 in home server (or information recording/playback apparatus) 1. That is, optical energy supplied from recording/playback unit 18 is received by solar cell 26, and electric power is supplied from light-receiving type power generation unit 27 to respective chips.

In the above example, an information reception unit (photodetector 24) by means of light and an information transmission unit (light-emitting element 30) by means of light are independent elements arranged at separate places, but they may be concentrated at one place. That is, a light transmission/reception element that incorporates LED light-emitting element 30a and high-speed photodiode 30b in one package may be used. Using such element in one package, alignment (position adjustment) upon face-to-face setting of a light transmission/reception element (not shown) on the recording/playback unit 18 side and that on the memory card 31y side is facilitated. (Upon simultaneously aligning independent light transmission units and light-receiving units at two places, high mechanical precision is needed accordingly. However, when the light transmission units and light-receiving units are separately arranged, any mutual interference between transmitted light and received light can be avoided upon simultaneously making light transmission and light reception.)

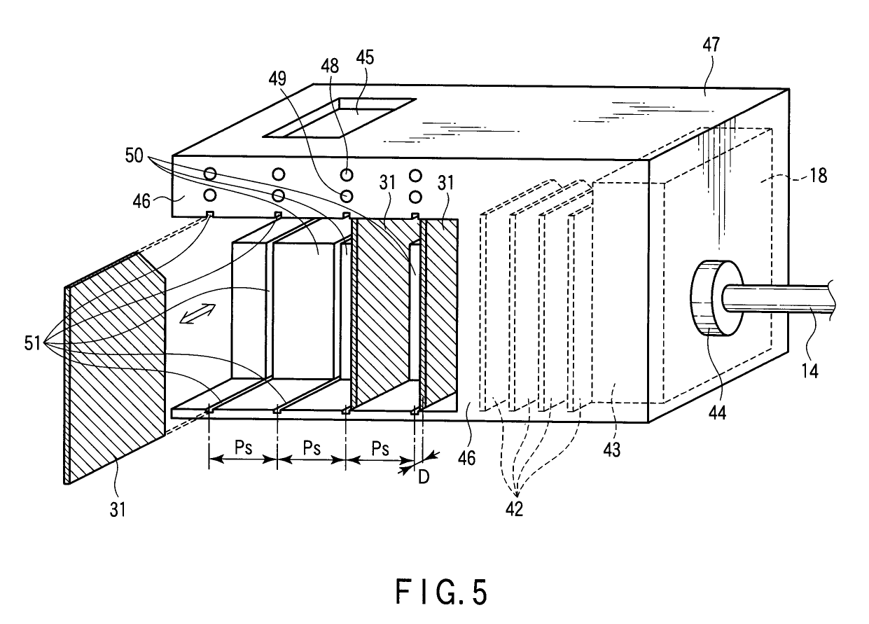

FIG. 5 is a view for explaining an example of a memory reservoir shelf (memory card bank) according to the embodiment of the invention. As has been described above using FIG. 1, home server (or information recording/playback apparatus) 1 according to the embodiment of the invention is mechanically divided into control unit 17 and recording/playback unit 18, which are connected via special (dedicated) cable 14. FIG. 5 shows the structure of this recording/playback unit 18. Special cable 14 mentioned above is electrically connected to recording/playback unit 18 via connector 44 for the special cable. Various kinds of information transferred via this special cable 14 are directly input to intra-recording/playback unit controller 43. Note that recording/playback unit 18 incorporates in advance built-in information storage media 42 each having the same structure as information recording chip 32 described above with reference to FIG. 3 or 4. This is also a characteristic feature of this embodiment.

Various kinds of information directly transferred from control unit 17 in home server (or information recording/playback apparatus) 1 to intra-recording/playback unit controller 43 undergo serial-to-parallel conversion (to be time-serially finely divided) in this intra-recording/playback unit controller 43, and are temporarily recorded in all built-in information storage media 42 (distributed allocation recording) at the same time. Even when the transfer rate of information to one flash memory unit 33 described in FIG. 3 or 4 is relatively low, since distributed recording processing (parallel transfer) based on serial-to-parallel conversion is executed, as described above, a practical transfer rate can be greatly improved (in the embodiment shown in FIG. 5, since four built-in information storage media 42 are incorporated, the practical transfer rate can be improved to nearly four times).

Upon completion of information recording in these built-in information storage media 42, control unit 17 in information recording/playback apparatus (home server) 1 simultaneously plays back information temporarily recorded in all built-in information storage media 42, executes parallel-to-serial conversion of played-back information in intra-recording/playback unit controller 43 (to combine individual pieces of distributed-allocation-recorded information into one time series), and then executes re-recording processing of that information in one detachable information storage medium 31. The faster this re-recording processing is, the better. However, this re-recording processing can be slower than a rate needed for real-time recording of digital broadcasting. Upon completion of the re-recording processing, control unit 17 executes delete processing of the information temporarily recorded in built-in information storage media 42.

In this way, the transfer rate of information to information recording/playback apparatus (home server) 1 when viewed from modem router 3 connected via optical cable 11 or various devices in the home network system connected via EHDMI cables 12 can be greatly improved, and a control time period that uses a time period in which no information transfer is made in optical cable 11 or EHDMI cables 12 can be effectively used (for example, information buffered in media 42 can be moved to medium 31 using that time period).

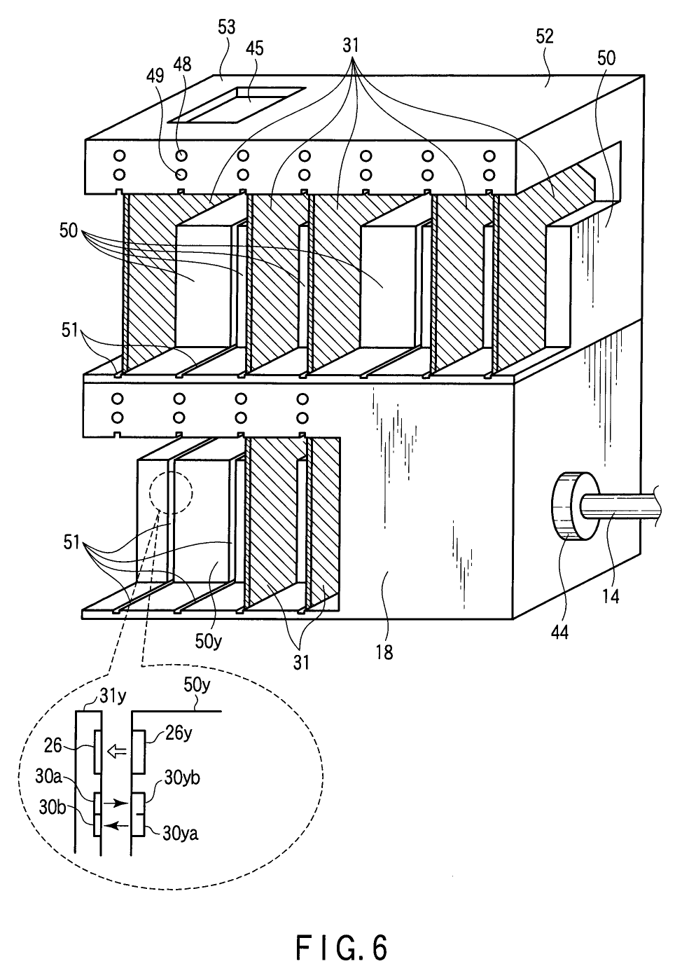

Detachable information storage medium 31 (memory card 31x or 31y) having the structure shown in FIG. 3 or 4 is loaded in recording/playback unit 18 by sliding it along information storage medium insertion guide 51. In a state in which this detachable information storage medium 31 is attached, each information input/output connection unit 50 is arranged at its neighboring position. When detachable information storage medium 31 has the structure shown in FIG. 3, this information input/output connection unit 50 incorporates an antenna, and executes power supply (electric power energy) and input/output processing of various kinds of information with respect to detachable information storage medium 31 (memory card 31x) via radio waves. When information storage medium 31 has the structure shown in FIG. 4, this information input/output connection unit 50 incorporates a light-emitting element and light-receiving element, and executes power supply (electric power energy) and information recording processing using the light-emitting element, and information playback processing using the light-receiving element with respect to detachable information storage medium 31 (memory card 31y) (see a lowermost part of FIG. 6 to be described later).

As shown in FIG. 5, even when arbitrary detachable information storage medium 31 is attached, the information recording/playback apparatus has a structure in which medium 31 (memory card 31x or 31y) does not stick out from outer wall 46 of the apparatus. More specifically, the information recording/playback apparatus is designed so that the surface on the frontmost side of detachable information storage medium 31 when it is attached recedes from outer wall 46 of the information recording/playback apparatus by length D. With this layout, even when the user touches outer wall 46 of the information recording/playback apparatus, he or she does not directly touch a part of detachable information storage medium 31, thus allowing stable information recording/playback processing with respect to information storage medium 31. The dimensional precision of mechanical parts is ±0.03 mm as the highest precision, and is generally ±0.2 mm. Therefore, in order to provide this recording/playback unit 18 to the user at low cost, it is recommended to set the value of D to be 0.2 mm or more. When no problem is posed if this recording/playback unit 18 is relatively expensive, the value of D is set to be 0.03 mm or more at minimum.

Furthermore, when the disengagement processing of this detachable information storage medium 31 from recording/playback unit 18 is premised on user's pulling-out processing, this recording/playback unit 18 can be provided to the user at lower cost. As a practical disengagement processing method, the user inserts the fingers into gaps (each between insertion guides 51 of neighboring information storage media and at a position in front of information input/output connection unit 50) between a plurality of attached detachable information storage media 31, and pulls out detachable information storage medium 31 while holding it with the two fingers. In order to allow this pulling-out processing, a gap between detachable information storage media 31 arranged at neighboring positions is set to be a specific length or more. Let Ps be a gap between neighboring attached information storage media 31, and T be the thickness of information storage medium 31, as shown in FIG. 3. Then, this gap is Ps−T. Since the finger width of male adults is around 1.5 cm, this value of Ps−T is set to be 0.5 cm (⅓ of 1.5 cm) at minimum, and it is recommended to set a gap of 1.5 cm.

In the embodiment shown in FIG. 5, individual information storage medium operation status indication lamp 49 (e.g., an LED which emits green light) and information storage medium recording status indication lamp 48 (e.g., an LED which emits red light) are arranged for each detachable information storage medium 31 as standard equipments. When a plurality of detachable information storage media 31 are attached to this recording/playback unit 18, it is difficult in practice for the user to determine which information storage medium 31 is in use. When individual information storage medium operation status indication lamp 49, which is arranged above a corresponding medium, is turned on upon accessing to or playing back various kinds of contents information or management information, the user can recognize information storage medium 31 which records specific information. Furthermore, when information storage medium recording status indication lamp 48 is turned on upon recording information on specific information storage medium 31, the user can be prevented from disengaging information storage medium 31 during recording by mistake. Note that electric signal connecting part 45 for a recording/playback expansion unit is formed on upper surface 47 of the recording/playback unit.

FIG. 6 is a view for explaining another example of a memory reservoir shelf (memory card bank) according to the embodiment of the invention. Electric signal connecting part 45 for a recording/playback expansion unit is formed on upper surface 47 of the recording/playback unit (see FIG. 5). Recording/playback expansion unit 52 is placed immediately on recording/playback unit 18 by electrically connecting it via this electric signal connecting part 45, thereby expanding the recording/playback unit, and increasing the recordable capacity in information recording/playback apparatus (home server) 1. FIG. 6 shows an application example in which recording/playback expansion unit 52 is added on upper surface 47 of the recording/playback unit. Electric signal connecting part 45 for another recording/playback expansion unit is also formed on upper surface 53 of recording/playback expansion unit 52, and next recording/playback expansion unit 52 can be placed on recording/playback expansion unit 52 by electrically connecting it via this electric signal connecting part 45, thereby also expanding the information recording/playback apparatus. In this embodiment, the number of recording/playback expansion units 52 to be added is basically not limited as long as a high mechanical strength is assured.

This recording/playback expansion unit 52 does not incorporate any built-in information storage media 42 unlike recording/playback unit 18, but it allows to attach a large number of detachable information storage media 31. In this recording/playback expansion unit 52, information storage medium insertion guides 51 are also formed, and detachable information storage medium 31 is attached along each information storage medium insertion guide 51. In a state in which this detachable information storage medium 31 is attached, each information input/output connection unit 50 is arranged at its neighboring position. Also, individual information storage medium operation status indication lamps 49 and information storage medium recording status indication lamps 48 are arranged in correspondence with respective detachable information storage media 31.

When information storage medium 31 is memory card 31y having the arrangement shown in FIG. 4, and its light transmission and reception elements are assembled in one package, feeding light source (high-luminance LED) 26y and light transmission and reception elements (LED 30ya that allows high-speed blinking+high-speed photodiode 30yb) having an arrangement bounded by the broken line in a lowermost part in FIG. 6 are arranged in input/output connection unit 50y for that card.

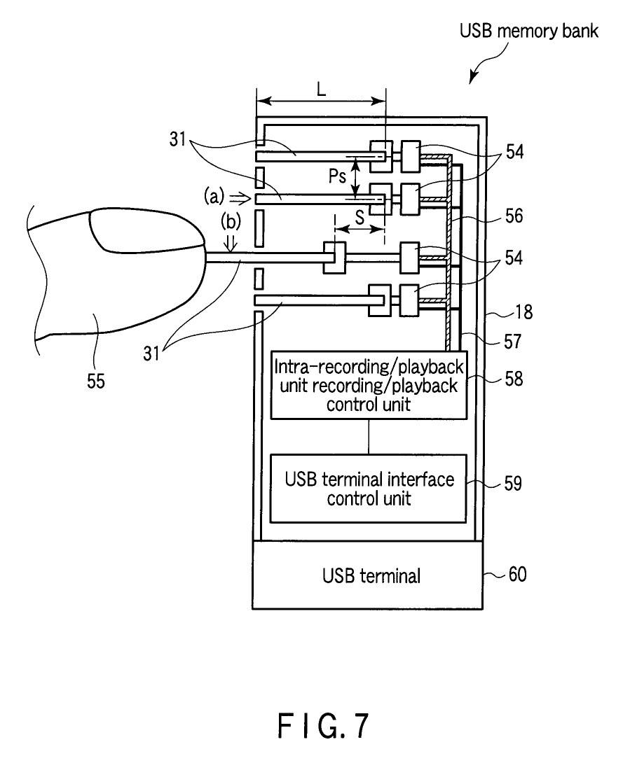

FIG. 7 is a view for explaining a memory reservoir shelf (USB memory card bank) according to another embodiment of the invention. This USB memory bank configures recording/playback unit 18. In this embodiment, USB terminal 60 is used to connect control unit 17 in information recording/playback apparatus (home server) 1, and USB terminal interface control unit 59 is incorporated. This recording/playback unit 18 incorporates intra-recording/playback unit recording/playback control unit 58, which issues instructions to USB terminal interface control unit 59 and executes information transfer control to respective information storage media 31. Bus lines connected to this intra-recording/playback unit recording/playback control unit 58 include data bus line 56 used to transfer various kinds of information to respective information storage media 31, and control bus line 57 used to issue commands to respective information storage media 31 and to recover statuses from respective information storage media 31. In the embodiment shown in FIG. 7, built-in information storage media 42 are not arranged as standard equipments. An edge of a part of information storage medium (small memory card) 31 used in this embodiment has electric contacts (not shown) for connection with an external device and power feeding.

Sockets 54 are arranged on the reception side where information storage media 31 is attached. When the electrode-equipped edge of each information storage medium 31 is inserted into this socket 54, information storage medium 31 is mechanically locked while an electric connection is established. This socket 54 has a spring back structure like a knock type ballpoint pen, which extends by length S when information storage medium 31 is inserted deeper (to push back information storage medium 31). For this reason, when information storage medium 31 partially projects from recording/playback unit 18 in a state in which the socket extends by length S (a state that changes from (a) to (b)), the user can execute disengagement processing by taking the projected end of information storage medium 31 between the fingers.

The structure shown in FIG. 7 need not always satisfy Ps−T≧0.5 mm with respect to distance Ps between neighboring information storage media and thickness T of information storage medium 31 upon attachment of information storage medium 31. However, when Ps is too short with respect to the outer dimensions of information storage medium 31, it becomes hard to use information storage medium 31. When Ps is too short, another information storage medium 31 may be pushed by mistake depending on the way finger 55 pushes the medium. As can be seen from examination results of easy-to-use limits by prototype tests, Ps/L≧0.1 (L means the length of information storage medium 31, as shown in FIG. 3), Ps/W≧0.1 (W means the width of information storage medium 31, as shown in FIG. 3), or Ps/S≧0.1 needs to be satisfied as an indispensable condition, and a condition Ps/L≧0.5, Ps/W≧0.5, or Ps/S≧0.5 is recommended.

The apparatus or home server using information storage media according to the embodiment of the invention includes the following contents:

1. <<Gap between neighboring memory cards upon attachment is formed to allow finger insertion>>

An information recording/playback apparatus or a home server is characterized by comprising a plurality of connection units (sockets or wireless/infrared communication I/F units) which exchange information with detachable information storage media that can record and play back the information,

in which letting Ps be a gap between the neighboring information storage media upon attachment, and T be a thickness of each information storage medium, a value of Ps−T becomes 5 mm or more.

2. <<Part of memory card upon loading does not stick out from outer wall of information recording/playback apparatus>>

An information recording/playback apparatus or a home server, which can simultaneously attach a plurality of detachable information storage media that can record and play back the information, is characterized by including a structure that can present at least one information storage medium upon attaching the plurality of information storage media from sticking out from an outer wall of the information recording/playback apparatus.

3. Simultaneous recording of a content in a plurality of information storage media in the same format is inhibited (synchronous recording of an identical content in different information storage media for respective different formats is permitted).

4. A playback unit (cell) of a content is definable in each individual information storage medium (a setting of a cell in a plurality of information storage media is inhibited), and its management information (cell information CI) includes identification information of an information storage medium.

5. Management information associated with playback is recorded for each information storage medium, and a menu is allowed to be displayed by merging the management information recorded in respective information storage media.

6. Information which allows to estimate at least a recording time for each specific unit (basic unit VOBU of an object) in a content is recorded together with the content.

7. When an identical content is distributed and recorded in a plurality of information storage media, the content can be played back in the order of recording times.

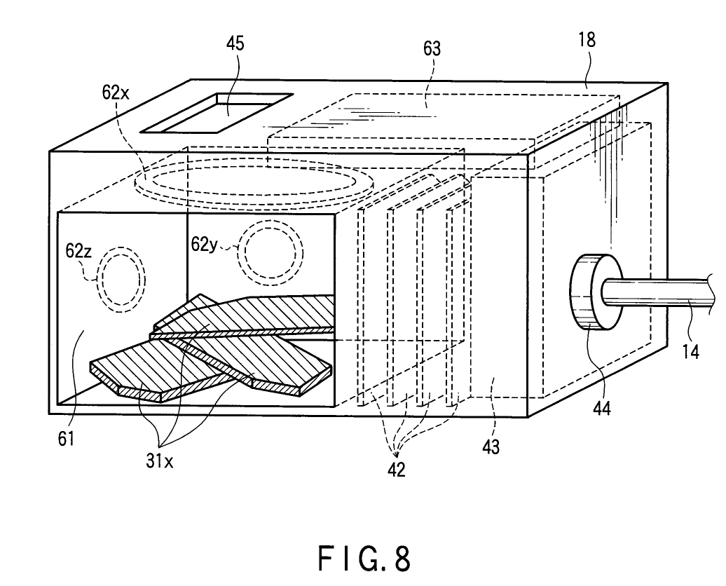

FIG. 8 is a view for explaining a memory reservoir shelf (a memory card bank having a storage unit like a microwave oven/heater) according to still another embodiment of the invention. FIG. 8 shows another embodiment associated with recording/playback unit 18 in information recording/playback apparatus (home server) 1 shown in FIG. 1. In recording/playback unit 18 shown in FIG. 5 or 7, upon attaching detachable information storage media 31 to recording/playback unit 18, this information storage medium 31 needs to be inserted along information storage medium insertion guide 51 or socket 54, thus needing user's troublesome operations. In the arrangement of recording/playback unit 18 shown in FIG. 8, the user need only place detachable information storage media 31 in storage place (memory card storage cavity) 61 of detachable information storage media.

In the example of FIG. 8, information storage media 31x which are free to take in and out are placed in piles in storage place 61 of detachable information storage media (memory cards having the structure in FIG. 3) 31x. When the user wants to attach new information storage medium 31x to this recording/playback unit 18, he or she need only place it on current uppermost detachable information storage medium 31 or need only drop it in an offhand manner. (Since individual memory cards can be identified by their card specific IDs, the pile-up state of memory cards in cavity 61 can be arbitrary.) As a result, the need for user's insertion processing of detachable information storage medium 31 can be obviated, thus greatly improving user's convenience. Since information storage media 31 shown in FIG. 3 allow information input/output (recording/playback) processing and power feeding via wireless communications, information input/output (recording/playback) processing and power supply processing for information storage media 31 can be made by supplying needed currents to information input/output (recording/playback) & power supply antenna 62x for information storage media, which is arranged on the top surface of storage place 61 (and to auxiliary antennas 62y and 62z in directions perpendicular to antenna 62x). Driving currents to these antennas 62 (antennas 62x to 62z) are supplied from antenna driving circuit unit 63. A wireless communication has a characteristic feature in that a communication is most stable when loop-shaped antennas on the transmitting and receiving sides face in the same direction (the carrier amplitude to be transferred is large), and a wireless communication is hard to make when these antennas have an orthogonal relationship. However, when the antennas are arranged in orthogonal three-axis directions x, y, and z, as shown in FIG. 8, wireless communications and wireless power feeding can be attained independently of facing directions of information storage media 31x in storage place 61. That is, by only dropping information storage media 31x into storage place 61 in an offhand manner, these media are connected to the system and are ready to use in a plug-and-play manner.

In the example of FIG. 8, all information storage media 31x are horizontally placed in storage place 61. In case of such placement, as can be seen from FIG. 3, the loop plane in wireless communication antenna 35 in this information storage medium 31x faces the horizontal direction in FIG. 8. Since the loop plane of information input/output (recording/playback) & power supply antenna 62x for information storage media also faces the horizontal direction in FIG. 8, transmission and reception of wireless communications with respect to information storage medium 31x becomes most stable. For this reason, when information storage media 31x are always horizontally placed, auxiliary antennas 62y and/or 62z can be omitted.

When built-in information storage media 42 have the structure shown in FIG. 3, since these media 42 are vertically placed in recording/playback unit 18, if there is no auxiliary antenna 62z, the loop plane of wireless communication antenna 35 in each medium 42 has an orthogonal relationship with respect to that of information input/output (recording/playback) & power supply antenna 62x for information storage media. As a result, the influences of electromagnetic waves generated from information input/output (recording/playback) & power supply antennas 62 to information storage media 31x on built-in information storage media 42 can be maximally eliminated.

When the antennas are equipped in orthogonal three-axis directions x, y, and z, as shown in FIG. 8, built-in information storage media 42 may be frequency-separated to have the tuning frequency of wireless communication to be different from that of information storage media 31x, or they may be of an optical communication type, as shown in FIG. 4, or they may be of an electric contact connection type (not shown).

Note that electric signal connecting part 45 for a recording/playback expansion unit is formed on the upper surface of recording/playback unit 18, and recording/playback expansion unit 52 can be added on recording/playback unit 18 via electrical connections here, thus increasing the total recordable capacity.

The sequence of information in the home server in FIG. 1 using the arrangement shown in FIG. 8 will be described below. Various kinds of information (FIG. 1) transferred from modem router 3 via optical cable 11 are transferred into intra-recording/playback unit controller 43 (FIG. 8) in recording/playback unit 18 via control unit 17 in home server (information recording/playback apparatus) 1 and through special cable 14. These pieces of information undergo serial-to-parallel conversion in this intra-recording/playback unit controller 43, and are temporarily saved (temporarily recorded) in built-in information storage media 42 at high speed. Upon completion of temporary saving in built-in information storage media 42, various kinds of information read out from built-in information storage media 42 in accordance with an instruction from control unit 17 undergo parallel-to-serial conversion in intra-recording/playback unit controller 43. These pieces of information after the parallel-to-serial conversion are transferred to antenna driving circuit unit 63, which drives currents to information input/output (recording/playback) & power supply antennas 62 (antennas 62x to 62z) for information storage media 31x in correspondence with modulated signals corresponding to these pieces of information, thereby recording (saving) them in designated detachable information storage medium 31x.

On the other hand, information recorded in advance in each detachable information storage medium 31x is read by antennas 62 (antennas 62x to 62z) via a wireless communication, and is transferred to control unit 17 (see FIG. 1) via antenna driving circuit unit 63, intra-recording/playback unit controller 43, and special cable 14 in turn. After that, AV information or the like read from information storage medium 31x is displayed on TV monitor 8 from this control unit 17 via EHDMI cable 12.

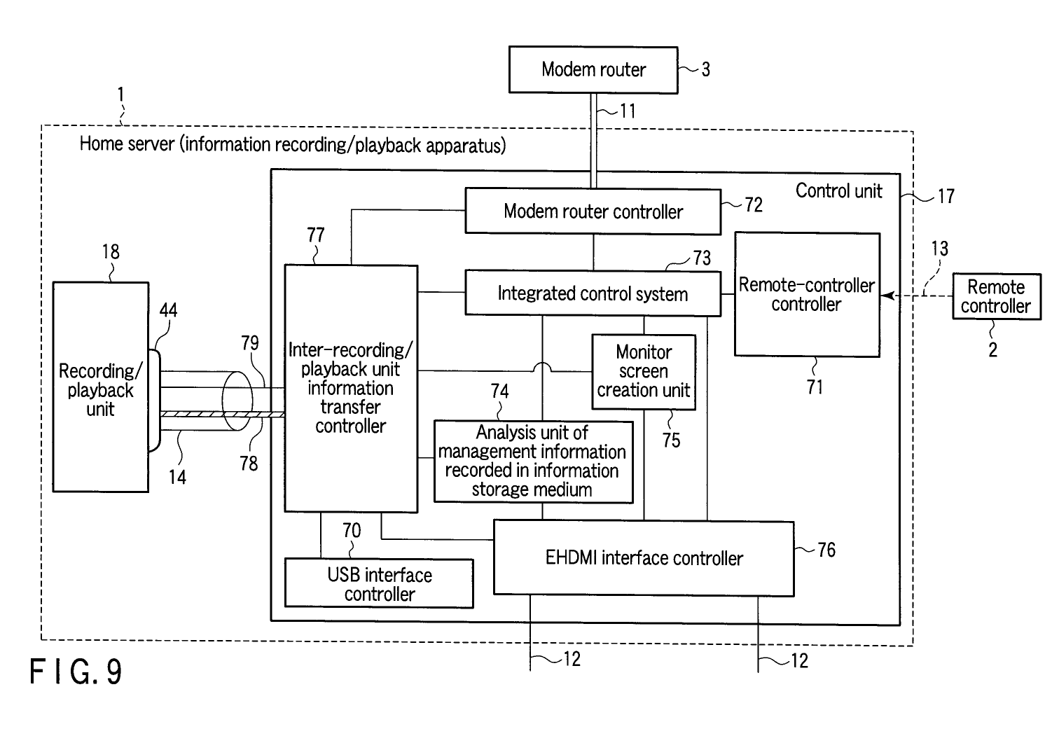

FIG. 9 is a block diagram for explaining an example of the arrangement of the control unit of the memory reservoir shelf (memory card bank). Control unit 17 shown in FIG. 1 has a system structure, as shown in FIG. 9. That is, infrared rays 13 output from remote controller 2 are received by remote-controller controller 71 in this control unit 17, and that reception result is transferred to integrated control system 73. This integrated control system 73 integrally controls respective parts in control unit 17 to execute input/output (recording/playback) control of various kinds of information among information storage media 31, menu screen display control for all pieces of information recorded in these information storage media, transfer control of various kinds of information based on a user request input using the remote controller, and the like.

Various kinds of information transferred from modem router 3 via optical cable 11 are transferred into modem router controller 72. The type (video information, audio information, still image information, or general computer information) of these pieces of information transferred into this modem router controller 72, and attribute information and management information associated with these pieces of information are input to integrated control system 73 described above, which controls home server (information recording/playback apparatus) 1 to optimally operate.

On the other hand, information such as video information or the like that needs high-speed transfer without interruption is directly transferred from modem router controller 72 to inter-recording/playback unit information transfer controller 77. This inter-recording/playback unit information transfer controller 77 controls information transfer processing between control unit 17 and recording/playback unit 18, and information transfer or move processing between built-in information storage media 42 and detachable information storage media 31 attached in recording/playback unit 18. Note that special cable (dedicated cable) 14 which connects between control unit 17 (corresponding to data bus line 56 in FIG. 7) and recording/playback unit 18 includes data line 78 used to transfer various kinds of information themselves and control line 79 (corresponding to control bus line 57 in FIG. 7) used to transfer command information to each individual information storage medium 31, and to recover status information.

Note that the USB memory bank shown in FIG. 7 is connected to inter-recording/playback unit information transfer controller 77 via USB interface controller 70.

Each individual detachable information storage medium 31 also records in advance management information associated with various kinds of information which have already been recorded. This management information recorded in each individual information storage medium 31 is read under the control of inter-recording/playback unit information transfer controller 77, and is sent to analysis unit 74 of management information recorded in an information storage medium. This analysis unit 74 analyzes management information in all information storage media 31, and merges the analysis results as a whole to form source information of a menu screen. This formation result is transferred to monitor screen creation unit 75, which creates a menu screen to be displayed for the user. The created menu screen is transferred from EHDMI interface controller 76 via EHDMI cable 12, and is displayed on TV monitor 8 (see FIG. 1). On the other hand, when information such as video information or the like that needs high-speed transfer without interruption is played back from information storage medium 31, it is directly transferred from inter-recording/playback unit information transfer controller 77 to TV monitor 8 via EHDMI interface controller 76.

In the hierarchical structure in the EHDMI communication that has already been described using FIG. 2, EHDMI interface controller 76 directly controls Ethernet layer 21 (physical layer) and TCP/IP layer 22 (communication protocol). By contrast, various commands issued by DLNA layer 23 (command designation) are generated in EHDMI interface controller 76 based on an instruction from integrated control system 73 or the analysis result of the analysis unit 74 of management information recorded in information storage media.

A large characteristic feature of the embodiment of the invention lies in that control unit 17 and recording/playback unit 18 are isolated by special cable 14 in home server (information recording/playback apparatus) 1, as shown in FIG. 9. As a result, not only this control unit 17 alone can be sold at a low price, but also easy exchange with recording/playback unit 18 having an arbitrary maximum capacity is allowed.

Likewise, since the USB memory bank shown in FIG. 7 is also isolated from home server 1, alone USB memory bank product can be sold at a low price, and when a plurality of USB memory banks are daisy-chain connected, the storage capacity can be increased without wasting USB memory banks used so far.

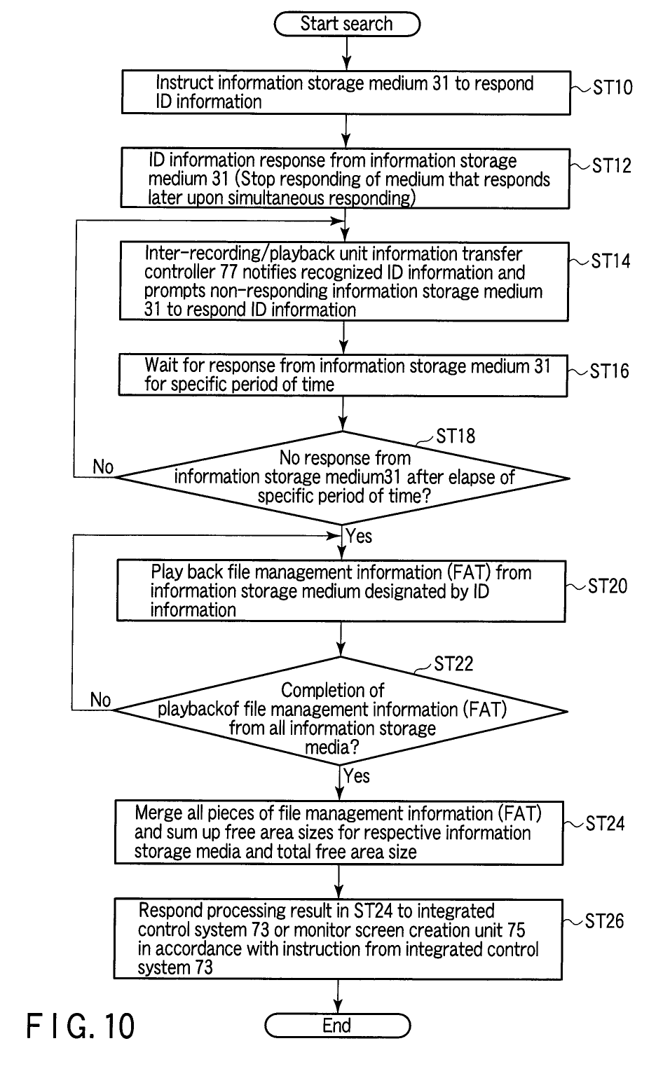

FIG. 10 is a flowchart for explaining an example of the sequence for searching for and merging free areas of one or more memory cards attached to or loaded in the memory reservoir shelf (memory card bank). The operation method as the home server in information recording/playback apparatus (home server) 1 will be described below with reference to FIG. 10. A method of detecting the types and file names of pieces of information recorded in all information storage media 31 attached to recording/playback unit 18, and free capacities (file management information) will be described first.

Individual identification information (see card specific ID in (a) of FIG. 21) is set in all information storage media 31 irrespective of a built-in type or detachable type, and is managed in intra-information storage medium controller 39 shown in FIG. 3 or 4. Therefore, inter-recording/playback unit information transfer controller 77 in control unit 17 manages information recorded in each individual information storage medium 31 using this identification information.

In FIG. 10, a plurality of detachable information storage media 31 are randomly placed under the condition of the structure of recording/playback unit 18 shown in, e.g., FIG. 8. Therefore, at the beginning of searching for file management information recorded in respective information storage media 31, “how many information storage media 31 are placed” and “ID information of each information storage medium 31” need to be checked first. As shown in FIG. 6 and the like, this recording/playback unit 18 allows easy addition of a plurality of recording/playback expansion units 52 via electric signal connecting parts 45 for recording/playback expansion units. Therefore, inter-recording/playback unit information transfer controller 77 in control unit 17 needs to execute above checking processing also for detachable information storage media 31 attached to these recording/playback expansion units 52.

Inter-recording/playback unit information transfer controller 77 in control unit 17 issues a command to request all detachable information storage media 31 (wireless memory card 31x) included in storage place 61 of detachable information storage media to respond ID information by supplying currents to information input/output (recording/playback) & power supply antennas 62 for information storage media via intra-recording/playback unit controller 43 and antenna driving circuit unit 63 arranged in recording/playback unit 18 (ST10).

Upon reception of this command, corresponding detachable information storage media 31 transmit and respond specific ID information (ST12).

At this time, a plurality of different detachable information storage media 31 may wirelessly transmit ID information simultaneously in some cases. If such simultaneous responses are generated, wireless transmission of information storage medium 31 which starts responding later is stopped, and that which starts responding earlier wirelessly transmits ID information a plurality of times. This radio signal is received by information input/output (recording/playback) & power supply antennas 62 for information storage media, is amplified in antenna driving circuit unit 63, and is then transferred to inter-recording/playback unit information transfer controller 77 via intra-recording/playback unit controller 43 and special cable 14.

When this inter-recording/playback unit information transfer controller 77 recognizes one ID information in this way, it notifies detachable information storage media 31 of all pieces of previously recognized ID information, and prompts non-responding detachable information storage media 31 to respond ID information (ST14). Immediately after this notification, controller 77 waits for responses from information storage media 31 only for a specific period of time (ST16). If there is information storage medium 31 having ID information, which is not recognized by inter-recording/playback unit information transfer controller 77, that medium returns a response during this specific period of time. However, if controller 77 recognizes the ID information of all information storage media 31, no response returns. Therefore, controller 77 checks if no response from information storage medium 31 returns during this specific period of time (ST18). If a response returns (NO in ST18), controller 77 repeats the processes from block ST14. If no response returns (YES in ST18), this inter-recording/playback unit information transfer controller 77 determines completion of collection of ID information of all detachable information storage media 31 including those in recording/playback expansion units 52, and collects file management information from all detachable information storage media 31.

In the embodiment of the invention, assume that file management information managed in all information storage media 31 is described in a FAT32 format (File Allocation Table) (see FIGS. 16 to 20). This inter-recording/playback unit information transfer controller 77 designates target detachable information storage medium 31 using the previously collected ID information, and plays back FAT32 information recorded in that medium (ST20). Upon completion of playback of the file management information (FAT) from all detachable information storage media 31 (YES in ST22), controller 77 sums up the sizes of free areas (areas that can record new information) for respective detachable information storage media and the total free area size by merging all the pieces of file management information (FAT) (ST24). After that, controller 77 returns the processing result in block ST24 to integrated control system 73 or monitor screen creation unit 75 in accordance with an instruction from integrated control system 73 (ST26).

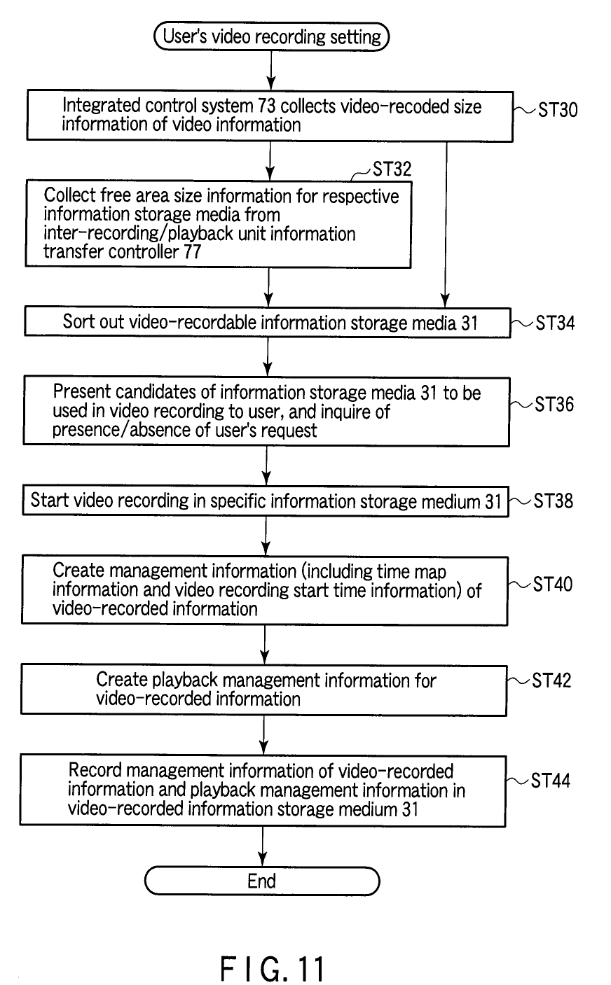

FIG. 11 is a flowchart for explaining an example of the sequence for recording information in one or more memory cards attached to or loaded in the memory reservoir shelf (memory card bank). A method of recording AV information such as video information (net-delivered movie), a digital TV broadcasting program, and the like transferred from modem router 3 in information storage media 31 will be described below. A case will be explained first wherein the video information size (detectable from a total time of a program scheduled to be video-recorded, and a recording rate used in video recording) to be video-recorded (recorded) is determined in advance.

When the user designates video recording using remote controller 2, that information is supplied to integrated control system 73 shown in FIG. 9 via remote-controller controller 71. Then, integrated control system 73 collects video information size information needed for video recording from modem router controller 72 (ST30). Integrated control system 73 issues an instruction to inter-recording/playback unit information transfer controller 77 to collect free area sizes in all detachable information storage media 31 (ST32). Since inter-recording/playback unit information transfer controller 77 has already collected the free area sizes in all detachable information storage media 31 by the method shown in FIG. 10, integrated control system 73 requests it to transfer that information. After that, integrated control system 73 searches, based on the video information size information needed for video recording collected in block ST30, for information storage media 31 each having a free area larger than this value, so as to sort out recordable information storage media (ST34).

Next, monitor screen creation unit 75 creates a menu screen including a candidate list table of recordable information storage media 31 sorted out by integrated control system 73. This screen is displayed on TV monitor 8 (see FIG. 1) via EHDMI interface controller 76 and the EHDMI cable to inquire about the presence/absence of a user's request (ST36). If the user inputs a request using remote controller 2, video recording on specific information storage medium 31 designated by the user (or that having a largest free area if there is no user's request) is started (ST38).

Upon completion of video recording, integrated control system 73 instructs analysis unit 74 to create management information of video-recorded information (ST40). The management information (see (h) of FIG. 21 or FIGS. 22 and 23) of this video-recorded information includes “video recording start time information” and “time map information” indicating the relationship between the playback time and recording location in information storage medium 31, and is recorded in identical information storage medium 31 as files (see files with “*” in FIG. 25) independent from the video-recorded video information.

Upon completion of this processing, integrated control system 73 instructs analysis unit 74 to create playback management information (see (g) of FIG. 21 or FIG. 24) associated with the video-recorded information (ST42). This playback management information (PGCI) is information indicating the playback order of the video information recorded in the information storage medium, and is recorded in identical information storage medium 31 as a file independent from the video-recorded video information and the management information (VOBI or SOBI) of the video-recorded information. After completion of the management information of this video-recorded information and the playback management information, analysis unit 74 records these pieces of information as independent files (see files with “*” in FIG. 25) in information storage medium 31 that records the video-recorded video information via inter-recording/playback unit information transfer controller 77 and recording/playback unit 18 under the control of integrated control system 73 (ST44).

The sequence in FIG. 11 will be explained below from another point of view. That is, when the video information size to be video-recorded (recorded) is not determined in advance, after pieces of free area size information for respective information storage media are collected from inter-recording/playback unit information transfer controller 77 (ST32), information storage media 31 are presented to the user in descending order of free area to inquire the user of a request as to whether or not he or she wants to record that video information in a specific information storage medium (ST36). If there is no specific designation from the user, video recording is sequentially done in turn from information storage media 31 with larger free areas.

In this case, video information to be video-recorded at the same time may be video-recorded (recorded) in a plurality of different detachable information storage media 31. In such case,

“management information of video-recorded information” including “video recording start time information” and “time map information” is recorded in only each detachable information storage medium 31 that records corresponding video information,

playback management information is recorded in all the plurality of different detachable information storage media 31 that video-record (record) the video information to be video-recorded at the same time to have the same contents, and

the playback management information includes pieces of ID information of information storage media 31 that video-record (record) the video information. This is a characteristic feature of the embodiment.

A practical method will be described below. When video information to be video-recorded at the same time is video-recorded (recorded) in a plurality of different detachable information storage media 31, a cell as a video playback unit is defined using a video recording unit recorded in single detachable information storage medium 31, and playback of information video-recorded in the plurality of different information storage media is allowed as a chain of these cells. This playback management information includes the playback order of cells, and management information associated with each of those cells. Especially, this management information associated with each cell includes ID information of detachable information storage medium 31 which records video information corresponding to this cell (see (g) of FIG. 21). In this way, detachable information storage media 31 to be played back and their playback order can be detected at the time of playback.

In the embodiment of the invention, the user can disengage arbitrary detachable information storage medium 31 from recording/playback unit 18. When the user detaches specific detachable information storage medium 31 from recording/playback unit 18, information storage medium 31 having the ID information recorded in the management information associated with each cell misses. In the embodiment of the invention, when video information video-recorded (recorded) in a plurality of different detachable information storage media 31 is to be played back, a cell corresponding to video information recorded in missing information storage medium 31 is skipped, and the next cell is played back. As a result, even when the user detaches specific detachable information storage medium 31 from recording/playback unit 18, playback of video-recorded video information can be guaranteed for the user without interrupting video playback.

Furthermore, as a result of detachment of many detachable information storage media 31 from recording/playback unit 18 by the user, the aforementioned playback management information often becomes insignificant at all. At this time, analysis unit 74 of management information recorded in an information storage medium collects pieces of “management information of video-recorded information” recorded in all detachable information storage media 31 attached to recording/playback unit 18, and reconstructs the playback management information by sorting cells in ascending order of video recording start time information using “video recording start time information” recorded in those pieces of information, based on an instruction from integrated control system 73. Then, analysis unit 74 of management information recorded in an information storage medium overwrites and corrects the reconstruction result in all related detachable information storage media 31 via inter-recording/playback unit information transfer controller 77 and recording/playback unit 18 under the control of integrated control system 73.

Finally, the menu screen to be displayed on TV monitor 8 will be described below. The embodiment of the invention has two different menu screens. That is, one of these screens corresponds to a menu screen which merges all of various kinds of information recorded in all detachable information storage media 31 attached to recording/playback unit 18 and recording/playback expansion units 52, and displays merged information as that recorded in a sole recording medium together. In this case, the user can record various kinds of information regardless of individual detachable information storage media 31. However, upon actually recording information, information storage medium recording status indication lamp 48 (see FIGS. 5 and 6), arranged immediately above detachable information storage medium 31, information recording of which is in progress, is turned on to indicate detachable information storage medium 31, video recording of which is in progress, for the user.

In the other display method, files and attributes already recorded in respective detachable information storage media 31 are displayed as in a display screen of a normal personal computer.

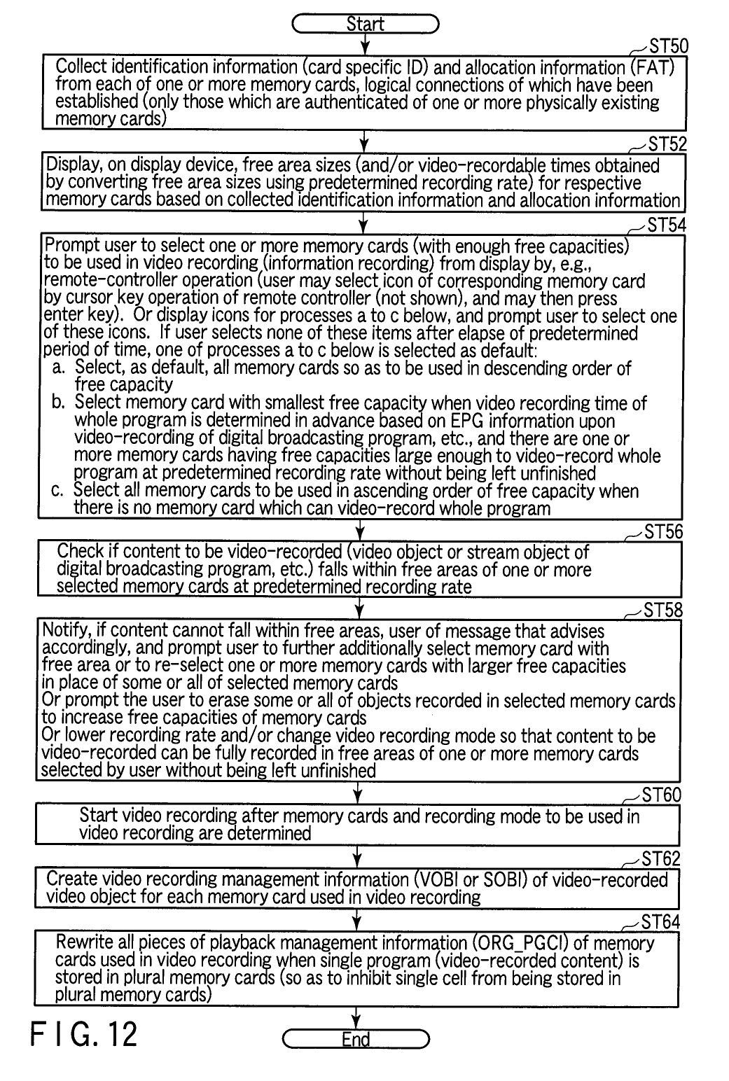

FIG. 12 is a flowchart for explaining an example of the sequence for video-recording AV information (single program) in one or more memory cards attached to or loaded in the memory reservoir shelf (memory card bank). A video recording method corresponding to a “case in which a single program is recorded in a plurality of different memory cards” will be explained.

Identification information (card specific ID) and allocation information (FAT) are collected from each of one or more memory cards, logical connections of which have been established (only those which are authenticated by the program in ROM 102 in (a) of FIG. 21 of one or more physically existing memory cards) (ST50). Based on the collected identification information and allocation information, free area sizes (and/or recordable times obtained by converting the free area sizes using a predetermined recording rate) are displayed on a display device for respective memory cards (ST52). (A memory card which has practically no free capacity (e.g., the free area size is 1% or less of the total recording area size) is displayed as an unrecordable card or is excluded from display targets.)

The control prompts the user to select one or more memory cards (with enough free capacities) to be used in video recording (information recording) by, e.g., a remote-controller operation (ST54). (The user may select an icon of a corresponding memory card by a cursor key operation of a remote controller (not shown), and may then press an enter key.) Alternatively, icons for processes a to c below are displayed, and the control prompts the user to select one of these icons. If the user selects none of these items after an elapse of a predetermined period of time, one of processes a to c below is selected as a default:

a. As a default, all memory cards are selected so as to be used in descending order of free capacity. (The possibility that a single memory card can cover recording of one program as a whole is raised. Even when one program is distributed and recorded in a plurality of memory cards, the number of memory cards used in distributed recording is reduced as much as possible) or

b. upon video-recording of a digital broadcasting program or the like, when the video recording time of a whole program is determined in advance based on EPG information, and there are one or more memory cards having free capacities large enough to video-record the program as a whole at a predetermined recording rate without being left unfinished, a memory card with the smallest free capacity is selected from those cards. (The full recording capacity of a memory card used up to its mid capacity is efficiently finished up as soon as possible. A memory card whose recording capacity is finished up may be write-protected or erase-protected as a read-only card) or

c. when there is no memory card which can video-record a whole program, all memory cards are selected to be used in ascending order of free capacity. (A memory card with a small free capacity is finished up as soon as possible, so that the remaining number of memory cards with small free capacities is hard to increase. A memory card whose recording capacity is finished up may be write-protected as a read-only card. The capacity of the finished-up memory card is covered by adding a new memory card. Note that each individual program can be write-protected using a protect flag in PGCI/PGI/PG_TY in place of the entire card.)

It is checked if a content to be video-recorded (video object or stream object such as digital broadcasting program) can fall within the free areas of one or more selected memory cards at a predetermined recording rate (ST56). For example, it is checked if the content to be video-recorded can fall within the free areas of one or more selected memory cards at 24 Mbps for MPEG-2 TS video recording, 6.0 Mbps or 8.0 Mbps for MPEG-4 AVC (H.264) TSE video recording, or 4.6 Mbps or 2.2 Mbps for MPEG-2 PS video recording.

If the content cannot fall within the free areas, the control notifies the user of a message that advises accordingly, and prompts the user to further additionally select a memory card with a free area or to re-select one or more memory cards with larger free capacities in place of some or all of the selected memory cards (ST58). Alternatively, the control may prompt the user to erase some or all of objects recorded in the selected memory cards to increase the free capacities of these memory cards. Alternatively, the recording rate is lowered, and/or a video recording mode is changed, so that the content to be video-recorded can be fully recorded in the free areas of one or more memory cards selected by the user without being left unfinished. For example, if a program for three hours is to be video-recorded when only a free capacity for one hour in a TS video recording mode at 24 Mbps is available, the video recording mode is changed to a TSE video recording mode at 8.0 Mbps.

After the memory cards and recording mode used in video recording are determined, video recording is started (ST60). After completion of the video recording, video recording management information (VOBI or SOBI) of a video-recorded video object is created for each memory card used in video recording (ST62). The created video recording management information (VOBI or SOBI) is recorded at two locations, as described above.

More specifically, the video recording management information (VOBI/SOBI) records video recording time information (video recording start time VOB_REC_TM/SOB_REC_TM), time map information (TMAPI/SOB_TMAPI), and the like. This video recording management information (VOBI/SOBI) is recorded in each memory card used in video recording, and at the head of each object file of the video-recorded content. Note that a time map (TMAP) is a data table used to convert a playback time in a video-recorded video object (VOB or SOB) into basic units (VOBUs or SOBUs) of that object. A video object unit (VOBU) is a unit which includes one or more GOPs or a reference picture, and corresponds to a duration of 0.4 sec to 1.0 sec (MPEG-2 PS video recording) when it is converted into a playback time. A stream object unit (SOBU) is a unit which includes one or more picture access units (PAUs) and corresponds to a duration of several sec or less (MPEG-2 TS video recording or MPEG-4 AVC TSE video recording) when it is converted into a playback time. This PAU corresponds to a GOP in MPEG-2, a GOVU in MPEG-4 AVC, and Group of Pictures in VC-1.

When a single program (video-recorded content) is recorded in a plurality of memory cards, all pieces of playback management information (ORG_PGCI) in memory cards used in video recording are rewritten (ST64). In this case, a single cell is inhibited from being recorded in a plurality of memory cards.

A case will be examined below wherein information which manages the playback order of cells C#1, C#2, . . . , C#k, . . . , C#n indicating playback units is playback management information (ORG_PGCI) and a single program is video-recorded in three memory cards 31a, 31k, and 31n. Then, as a result of rewriting of the playback management information (ORG_PGCI), two pieces of cell information CI#1 and CI#2 which manage the video playback start times and the like of cells C#1 and C#2 are written in ORG_PGCI of first memory card 31a, cell information CI#k which manages the video playback start time and the like of cell C#k is written in ORG_PGCI of second memory card 31k, and cell information CI#n which manages the video playback start time and the like of cell C#n is written in ORG_PGCI of third memory card 31n. These pieces of playback management information (ORG_PGCI) of the respective memory cards are merged as playback management information called PGC set information (PGCSI in (e) of FIG. 21). Playback management of the video-recorded content in the three memory cards is made using this PGCSI.

It should be noted that a single cell is inhibited from being recorded in a plurality of memory cards. When all the three memory cards are active, the recorded objects are played back in the order of C#1→C#2→C#k→C#n according to the description of management information PGCSI. When, for example, second memory card 31k is removed, the recorded objects are played back in the order of C#1→C#2→C#n. In this case, the recorded object corresponding to cell information CI#k is excluded from playback, but the recorded objects in remaining memory cards 31a and 31n are normally played back.

However, if cell C#k is stored in both of remaining memory card 31a (or 31n) and removed memory card 31k, it becomes impossible to play back a part of cell C#k stored in remaining memory card 31a (or 31n) as a result of removal of memory card 31k. For example, when cells C#1, C#2, C#k, and C#n are music pieces #1, #2, #k, and #n, if music piece #k is stored in two memory cards, and one of these memory cards is removed, music piece #k in the remaining memory card has a missing starting part or is left unfinished. Hence, when recording is done so that object data of a playback unit (cell) of a single content is inhibited from being stored in a plurality of memory cards, and its playback management information (ORG_PGCI) is created, for example, music piece #k is entirely cut as a result of removal of a given memory card, but it can be prevented from being played back to have a missing starting part or to be left unfinished.

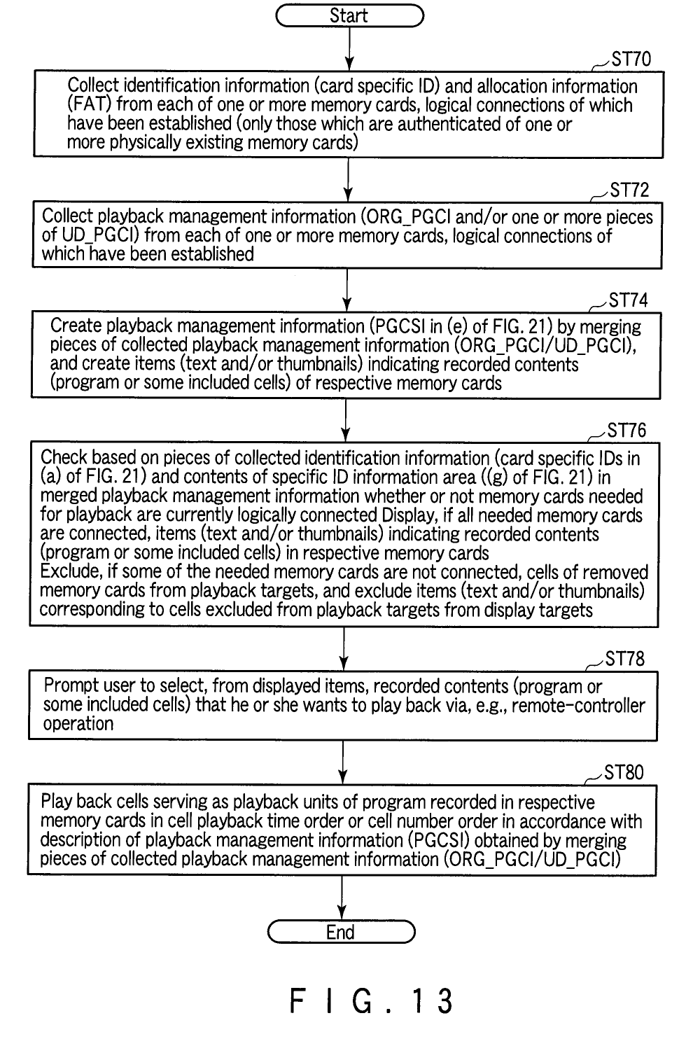

FIG. 13 is a flowchart for explaining an example of the sequence for playing back AV information (single program) video-recorded in one or more memory cards attached to or loaded in the memory reservoir shelf (memory card bank). In this case, a playback method corresponding to a “case in which all memory cards are inserted” will be explained.

Identification information (card specific ID) and allocation information (FAT) are collected from each of one or more memory cards, logical connections of which have been established (only those which are authenticated of one or more physically existing memory cards) (ST70). Playback management information (ORG_PGCI and/or one or more pieces of UD_PGCI) is collected from each of one or more memory cards, logical connections of which have been established (ST72). Playback management information (PGCSI in (e) of FIG. 21) is created by merging these pieces of collected playback management information (ORG_PGCI/UD_PGCI), and items (text and/or thumbnails) indicating the recorded contents (program or some included cells) of respective memory cards are created (ST74).

It is then checked based on the pieces of collected identification information (card specific IDs in (a) of FIG. 21) and the contents of the specific ID information area ((g) of FIG. 21) in the merged playback management information whether or not memory cards needed for playback are currently logically connected (whether or not some memory cards are removed during this processing) (ST76). If all needed memory cards are connected, the items (text and/or thumbnails) indicating the recorded contents (program or some included cells) in respective memory cards are displayed. If some of the needed memory cards are not connected, cells of the removed memory cards are excluded from playback targets. Also, the items (text and/or thumbnails) corresponding to the cells excluded from the playback targets are excluded from display targets.

The control prompts the user to select, from the displayed items, the recorded contents (program or some included cells) that he or she wants to play back via, e.g., a remote-controller operation (ST78). After that, cells as playback units of the program recorded in respective memory cards are played back in the cell playback time order or the cell number order in accordance with the description of the playback management information (PGCSI) obtained by merging the pieces of collected playback management information (ORG_PGCI/UD_PGCI) (ST80).

The aforementioned playback processing will be briefly summarized below. That is, pieces of playback management information (PGCI) recorded in all memory cards are read, the contents obtained by merging them are displayed on the TV monitor, and the user designates a video picture that he or she wants to watch. In this case, pieces of playback management information (PGCI) recorded in all the memory cards are read, and it is confirmed using memory card identification information (see (g) in FIG. 21) recorded in cell information (CI) in each of these pieces of playback management information if all the memory cards are inserted. Then, the playback sequence that plays back cells while skipping those corresponding to non-inserted memory cards is displayed on the TV monitor, and the user designates a video picture that he or she wants to watch (or designates automatic playback while skipping cells corresponding to non-inserted memory cards).

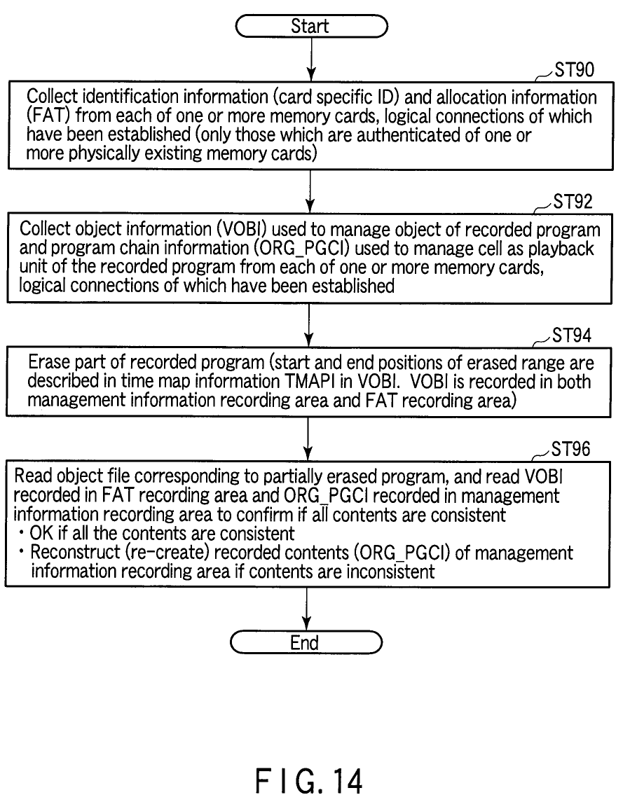

FIG. 14 is a flowchart for explaining an example of the sequence for editing (partially erasing) AV information video-recorded in one or more memory cards attached to or loaded in the memory reservoir shelf (memory card bank). Identification information (card specific ID) and allocation information (FAT) are collected from each of one or more memory cards, logical connections of which have been established (only those which are authenticated of one or more physically existing memory cards) (ST90). Object information (VOBI) used to manage an object of a recorded program and program chain information (ORG_PGCI) used to manage a cell as a playback unit of the recorded program are collected from each of one or more memory cards, logical connections of which have been established (ST92).

After that, a part of the recorded program is erased in accordance with a user's instruction or the like (ST94). (The start and end positions of the erased range are described in time map information TMAPI in the VOBI or SOBI. The VOBI or SOBI is recorded in both the management information recording area and FAT recording area.)

An object file corresponding to the partially erased program is read, and VOBI recorded in the FAT recording area and ORG_PGCI recorded in the management information recording area are read to confirm if all the contents are consistent (ST96).

If all the contents are consistent, “OK” is determined to end the edit processing; or

if the contents are inconsistent, the recorded contents (ORG_PGCI) in the management information recording area is reconstructed (re-created).

Whether or not the contents are consistent can be confirmed as follows. For example, if a predetermined time period defined by video playback time information (VOB_V_S_PTM/VOB_V_E_PTM) in the VOBI includes C_V_S_PTM (the video start time of a corresponding cell) included in each CI in the ORG_PGCI of each memory card, it is determined that the contents are consistent. If there is C_V_S_PTM indicating a time outside the predetermined time period, the contents are inconsistent.

The aforementioned edit processing will be briefly summarized below. That is, when only data of a specific object file is erased, or a specific memory card is removed, and when related playback management information (PGCI) goes to ruin, and needs to be reconstructed, pieces of playback management information (PGCI) of all memory cards, VOBI or SOBI management files, and recorded object files are read, and it is confirmed if all the contents are consistent. When the related VOBI or SOBI information has been changed, and the contents are inconsistent, the related playback management information (PGCI) is reconstructed.

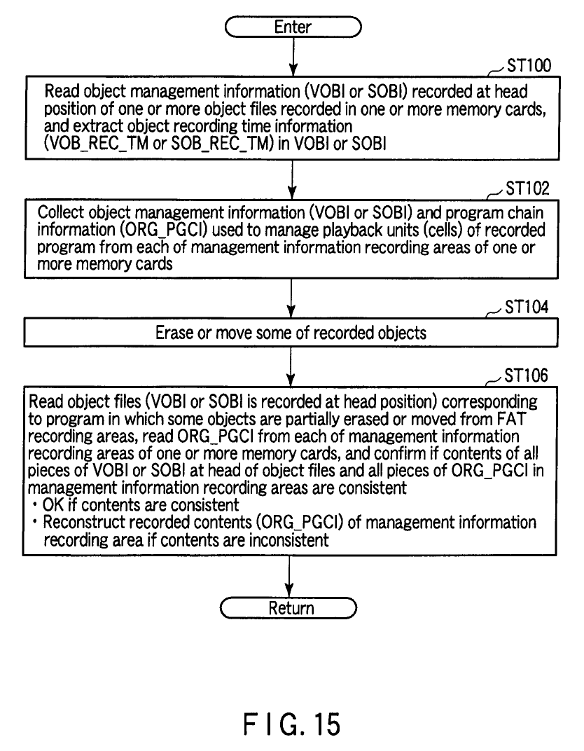

FIG. 15 is a flowchart for explaining an example of the sequence for reconstructing management information when AV information video-recorded in one or more memory cards attached to or loaded in the memory reservoir shelf (memory card bank) has been changed (partially erased or moved). In this case, a method corresponding to a “case in which VOBI recorded at the head of each object file is fed back to a VOBI management file, and playback management information (PGCI) is reconstructed using video recording start times recorded in the VOBI (to set ORG_PGCI in ascending order of video recording start time)” will be explained.

Object management information (VOBI or SOBI) recorded at the head position of one or more object files recorded in one or more memory cards is read, and object recording time information (VOB_REC_TM or SOB_REC_TM) in the VOBI or SOBI is extracted (ST100). Object management information (VOBI or SOBI) and program chain information (ORG_PGCI) used to manage playback units (cells) of the recorded program are collected from each of the management information recording areas of one or more memory cards (ST102).

After that, some of recorded objects are erased or moved (ST104). Information indicating the start and end positions of the erased or moved range is described in time map information TMAPI in the VOBI or time map information SOB_TMAPI in the SOBI. The VOBI or SOBI with this description is recorded in both the management information recording area and FAT recording area.

Object files (VOBI or SOBI is recorded at the head position) corresponding to the program in which some objects are partially erased or moved are read from the FAT recording areas, ORG_PGCI is read from each of the management information recording areas of one or more memory cards, and it is checked if the contents of all pieces of VOBI or SOBI at the head of the object files and all pieces of ORG_PGCI in the management information recording areas are consistent (ST106).

If the contents are consistent, “OK” is determined to end the processing (if “OK” is determined, the cell playback order of the whole program based on the ORG_PGCI does not go to ruin on the sequence of the playback time due to erasure or movement).

If the contents are inconsistent, the recorded contents (ORG_PGCI) of the management information recording areas are reconstructed. More specifically, the ORG_PGCI is re-set in ascending order of video recording start time (VOB_REC_TM or SOB_REC_TM) of memory cards which store the program including erased or moved objects. As a result, upon playing back the program which is recorded in one or more memory cards and includes erased or moved objects, cells are played back in the chronological order. More specifically, VOBI or SOBI recorded at the head of each corresponding object file is fed back to each of the management files of one or more memory cards.

### Effect of Embodiment

A content with a large size can be saved by, e.g., network downloading. More specifically, upon saving a content with a large size, distributed recording of that content in a plurality of information storage media is allowed, and continuous content playback is allowed even when a specific one of the plurality of information storage media that save the content is removed.

Since information storage media that can record various kinds of information can be arbitrarily expanded, large-size video information for a long period of time can be video-recorded, and even when the user disengages a specific information storage medium by mistake, the recorded video information can be continuously played back.

### Summary of Embodiments

(1) An information management method for a memory card bank

An information management method configured to file-manage digital information (AV information) to be (discretely) recorded on one or more information storage mediums (such as memory cards) according to a prescribed format (which is common to all of the information storage media), wherein

identification information (card-specific ID) is configured to be recorded on each of the mediums, the identification information identifying the medium on which the identification information is recorded, and

allocation information (FAT) is configured to be recorded as file management information on each of the mediums, the allocation information indicating that a part of the digital information is allocated at a place of the medium, the method comprising:

obtaining (ST10-ST22 in FIG. 10) the allocation information from one or more the mediums being identified by the identification information; and

integrating (ST24 in FIG. 10) the obtained allocation information.

(2) A card added to the memory card bank

When the number of the one or more information storage mediums is increased (the process of FIG. 10 is repeated), the allocation information is obtained (ST10-ST22 in FIG. 10) from the increased mediums, and the obtained allocation information is integrated (ST24 in FIG. 10).

(3) A card removed from the memory card bank (including a case wherein a physically loaded card is logically discarded by the system)

When a part (e.g., one of three memory cards) of the mediums is physically or logically removed from the one or more mediums (the process of FIG. 10 is repeated), the allocation information is obtained (ST10-ST22 in FIG. 10) from the remaining one or more mediums (e.g., two memory cards), and the obtained allocation information is integrated (ST24 in FIG. 10).

(4) Free space is displayed based on FAT being modified according to increase/decrease of the card, when the number of the cards in the memory bank is increased by adding other cards or decreased by removing any of the cards in the memory bank, the display comprising:

changing (ST10-ST24 in FIG. 10) the integrated allocation information in accordance with increase or decrease of number of the one or more mediums, when the number of the one or more mediums is increased or decreased (the process of FIG. 10 is repeated), and

displaying (ST26 in FIG. 10) a used state or a state of free space of the one or more mediums whose number is increased or decreased, in accordance with the changed integrated allocation information.

(5) Management method of recording, comprising:

detecting (ST32 in FIG. 11) from the integrated allocation information a recordable free area in the one or more mediums identified by the identification information,

recording (ST38 in FIG. 11) the digital information on the one or more mediums having the recordable free area (ST34 in FIG. 11), according to the prescribed format, and

managing (ST40-ST44 in FIG. 11) an allocation of the recorded digital information based on the integrated allocation information.

(6) Preparation of VOBI or SOBI, comprising:

respect to the digital information (corresponding to VOB or SOB) whose recording location on the one or more mediums is managed by the integrated allocation information, preparing (ST40 in FIG. 11) recording management information (VOBI or SOBI) including recording time information (VOB_GI containing VOB_REC_TM, and TMAPI; or SOBI_GI containing SOB_REC_TM, and SOB_TMAPI) of the recorded digital information.

(7) Preparation of PGCI, comprising:

with respect to the digital information (corresponding to VOB or SOB) whose recording location on the one or more mediums is managed by the integrated allocation information, preparing (ST42 in FIG. 11) presentation management information (PGCI) containing presentation start time information (C_V_S_PTM) and presentation end time information (C_V_E_PTM)of a presentation unit (cell) of the digital information.

(8) Recording a card-specific ID on CI

The presentation time (C_V_S_PTM/C_V_E_PTM) of the presentation unit (cell) of the digital information (corresponding to VOB or SOB) recorded on the one or more mediums is managed by cell information (CI). The presentation management information (PGCI) includes one or more items of the cell information (CI). Recording (ST44 in FIG. 11) on the cell information (CI) is identification information (IDa-IDn or specific file names in FIG. 21g) of the medium on which the digital information (VOB or SOB) corresponding to the cell information (CI) is recorded.

(9) Presentation of program recorded among or through a plurality of cards, comprising:

acquiring (ST72 in FIG. 13) each of items of presentation management information (ORG_PGCI/UD_PGCI) of one or more memory cards;

preparing (ST74 in FIG. 13) integrated presentation management information (PGCSI) from the acquired items of the presentation management information (ORG_PGCI/UD_PGCI); and

sequentially presenting (ST80 in FIG. 13) cells of the program recorded on the memory cards according to descriptions of the integrated presentation management information (PGCSI), each of the cells representing a unit of presentation of the program.

(10) Recording of a same program among or through a plurality of cards, comprising:

acquiring (ST50 in FIG. 12), from one or more memory cards, identification information (card specific ID) of each of the memory cards and allocation information (FAT) indicating a recording location of information of the memory cards;

detecting (ST52 in FIG. 12) where and how match a free space exists in each of the memory cards according to the acquired identification information and the acquired allocation information;

recording (ST60 in FIG. 12) a given program on one or more the memory cards in which the free space exists; and

preparing (ST64 in FIG. 12) presentation management information (ORG_PGCI) so that a same cell do not cover two or more the memory cards when a same program is recorded among or through a plurality of the memory cards, wherein the cell represents a unit of reproduction of the program to be recorded on the respective memory cards, and an order of reproduction of the cells is managed by the presentation management information (ORG_PGCI).

(11) Reconstruction of management information when a program recorded among or through plural cards is partly erased or moved. The reconstruction is applied to a case wherein

a program of digital information (corresponding to VOB or SOB) is recorded as an object file (VRO file or SRO file in FIG. 25) using one or more memory cards (31) each comprising a file management information recording area (FAT), a management information recording area (130), and an object recording area (131-134);

object management information (VOBI or SOBI) including recording time information (VOB_REC_TM or SOB_REC_TM) of an object corresponding to the recorded program is recorded at a leading portion (the file with * in FIG. 25) of the object file recorded on the one or more memory cards; and

a program chain information (ORG_PGCI) for managing a reproduction unit (cell) of the recorded program is recorded in the management information recording area (130) which is recorded on the on the one or more memory cards. The reconstruction comprises:

reading (ST100-ST102 in FIG. 15) the object management information (file with * with respect to VOBI or SOBI) recorded at the leading portion of the object file, and the program chain information (ORG_PGCI) recorded in the management information recording area (130); and

reconstructing (ST106 in FIG. 15), when the recorded object is partly erased or moved (ST104 in FIG. 15), the program chain information (ORG_PGCI) for the program of which object is partly erased or moved, using the program chain information (ORG_PGCI) arranged older with respect to the recording time information (VOB_REC_TM or SOB_REC_TM) of the objct.

(12) A combination of the apparatus of FIG. 9 and the memory bank of FIGS. 5 and 6, wherein digital information recorded on one or more memory cards is managed according to a predetermined format, and each of the memory cards records identification information configured to specify the memory card and allocation information configured to indicate where is allocated a portion of the digital information. A digital information recording/reproducing apparatus of the combination comprises:

a connector (50) with a guide (51) to which one of the one or more memory cards can be removably or detachably connected; and

a module (16 in FIGS. 5 and 6) configured to record and/or reproduce the digital information using

an acquirer (73 in FIG. 9, executing ST10-ST22 in FIG. 10) configured to acquire the allocation information of a particular one or ones of the one or more memory cards connected to the connector (50) and identified by the identification information, provided that a logical connection of the particular one or ones (excluding one or ones which is/are not recognized by the system) is established,

an integrator (73 in FIG. 9, executing ST24 in FIG. 10) configured to integrate the acquired allocation information, and

a recorder/reproducer (18 in FIGS. 5 and 6) configured to record and/or reproduce the digital information using the one or more memory cards managed by the integrated allocation information.

(13) A recorder/reproducer with a USB memory bank of FIG. 7, wherein digital information recorded on one or more memory cards is managed according to a predetermined format, and each of the memory cards records identification information configured to specify the memory card and allocation information configured to indicate where is allocated a portion of the digital information. A digital information recording/reproducing apparatus (FIG. 7) is connected to a controller (17 in FIG. 9). The controller acquires (73 in FIG. 9) allocation information of the one or more memory cards identified by the identification information, integrates (73 in FIG. 9) the acquired allocation information, and exchange (77 in FIG. 9) information with the one or more memory cards managed by the integrated allocation information. The digital information recording/reproducing apparatus comprises:

one or more sockets (54) configured to be removably or detachably connected (thorough slot or slots) with the one or more memory cards;

a recorder/reproducer (58 in FIG. 7) configured to record and/or reproduce the digital information using the one or more memory cards managed by the allocation information being integrated by the controller (17); and

a connection module (USB interface 59, USB terminal 60 in FIG. 7) configured to connect the recorder/reproducer (58 in FIG. 7) with the controller (17).

(14) A microwave-oven (heater/energizer)-like memory bank of FIG. 8 in combination with an apparatus of FIG. 9, wherein digital information recorded on one or more memory cards is managed according to a predetermined format, each of the memory cards records identification information configured to specify the memory card and allocation information configured to indicate where is allocated a portion of the digital information, and each of the memory cards (31x in FIG. 3) is provided with a card-side antenna (35 in FIG. 3) through which a radio-wave wireless information exchange as well as an electromagnetic-wave power supply are to be carried out. A digital information recording/reproducing apparatus comprises:

a container cavity (61 in FIG. 8) configured to contain the one or more memory cards (31x);

an apparatus-side antenna (62x-62z in FIG. 8) configured to send an electromagnetic wave to each of the one or more memory cards in the container cavity (61), said electromagnetic wave having a power supply energy;

acquirer module (73 in FIG. 9) configured to acquire the allocation information of each of the one or more memory cards identified by the identification information, the one or more memory cards in the container cavity (61) being power-supplied with the electromagnetic wave from the apparatus-side antenna (62x-62z), and a logical connection of the power-supplied one or more memory cards being established;

an integrator module (73 in FIG. 9) configured to integrate the acquired allocation information; and

a recorder/reproducer module (18 in FIG. 18) configured to record the digital information on the one or more memory cards or to reproduce the digital information from the one or more memory cards, the one or more memory cards being managed by the integrated allocation information.

(15) A memory bank having optical transmitter/receiver in combination with an apparatus of FIG. 9, wherein digital information recorded on one or more memory cards is managed according to a predetermined format, each of the memory cards records identification information configured to specify the memory card and allocation information configured to indicate where is allocated a portion of the digital information, each of the memory cards (31y in FIG. 4) is provided with an optical element (30a, 30b in FIG. 4; or 24, 30) through which an optical information exchange is to be carried out, and each of the memory cards (31y in FIG. 4) is provided with a solar cell (26 in FIG. 4) configured to supply power. A digital information recording/reproducing apparatus comprises:

a guide (51 in FIG. 6) to which one of the one or more memory cards can be removably or detachably set; and

an optical transmitter/receiver module (30ya, 30yb, 26y in FIG. 6) configured to transmit light to the optical element (30a, 30b in FIG. 6) and the solar cell (26 in FIG. 6) and configured to receive light from the optical element (30a in FIG. 6), the optical transmitter/receiver module being located at a light receiving side of the one or more memory cards arranged along the guide (51);

an acquirer module (73 in FIG. 9) configured to acquire the allocation information of each of the one or more memory cards identified by the identification information, the one or more memory cards (31y) being operated with power supplied from the solar cell (26) on which the light is irradiated, and a logical connection of the powered one or more memory cards being established via the optical element (30a, 30b);

an integrator module (73 in FIG. 9) configured to integrate the acquired allocation information; and

a recorder/reproducer module (18 in FIG. 5, 6) configured to record the digital information on the one or more memory cards or to reproduce the digital information from the one or more memory cards, the one or more memory cards being managed by the integrated allocation information.

(16) A memory card (FIG. 3) with an antenna, comprising a digital information recording area configured to record digital information, an identification information recording area configured to record identification information for specifying oneself, and an allocation information recording area configured to record allocation information. The allocation information is configured to indicate where is allocated a portion of the digital information. The antenna is configured to carry out a radio-wave wireless information exchange and an electromagnetic-wave power supply.

(17) A memory card (FIG. 4) with a photoelectric element and a solar cell, comprising a digital information recording area configured to record digital information, an identification information recording area configured to record identification information for specifying oneself, and an allocation information recording area configured to record allocation information. The allocation information is configured to indicate where is allocated a portion of the digital information. The photoelectric element is configured to carry out information exchange by light (wherein an LED may be used as a light information transmitter, and a photodiode or a solar cell may be used as a light information receiver). The solar cell is configured to supply electric power by light.

While certain embodiments of the invention have been described, these embodiments have been presented by way of example only, and are not intended to limit the scope of the invention. For example, a memory card formed of a flash memory or the like is exemplified for one or more recording mediums. However, a hard disk drive (HDD) or a recordable optical disc loaded in an optical disc drive may be used for the one or more recording mediums, in addition to or in place of the flash memory. Indeed, the novel methods and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention. The various modules of the systems described herein can be implemented as software applications, hardware and/or software modules, or components on one or more computers, such as servers. While the various modules are illustrated separately, they may share some or all of the same underlying logic or code.

What is claimed is:

1. An information management method configured to file-manage digital information to be recorded on one or more information storage mediums according to a prescribed format, wherein
identification information is configured to be recorded on each of the mediums, the identification information identifying the medium on which the identification information is recorded, and
allocation information is configured to be recorded as file management information on each of the mediums, the allocation information indicating where is allocated a portion of the digital information, the method comprising:
acquiring the allocation information from one or more the mediums being identified by the identification information; and
integrating the acquired allocation information.

2. The method of claim 1, wherein when a number of the one or more information storage mediums is increased, the allocation information is acqured from the increased mediums, and the acqured allocation information is integrated.

3. The method of claim 1, wherein when a part of the mediums is physically or logically removed from the one or more mediums, the allocation information is acquired from remaining one or more mediums, and the acquired allocation information is integrated.

4. The method of claim 1, wherein when a number of the one or more mediums is increased or decreased, the method comprising:
changing the integrated allocation information in accordance with increase or decrease of number of the one or more mediums, and
displaying a used state or a state of free space of the one or more mediums whose number is increased or decreased, in accordance with the changed integrated allocation information.

5. The method of claim 1, further comprising:
detecting from the integrated allocation information a recordable free area in the one or more mediums identified by the identification information,
recording the digital information on the one or more mediums having the recordable free area, according to the prescribed format, and
managing an allocation of the recorded digital information based on the integrated allocation information.

6. The method of claim 5, further comprising:
with respect to the digital information whose recording location on the one or more mediums is managed by the integrated allocation information, preparing recording management information including recording time information of the recorded digital information.

7. The method of claim 5, further comprising:
with respect to the digital information whose recording location on the one or more mediums is managed by the integrated allocation information, preparing presentation management information containing presentation start time information and presentation end time information of a presentation unit of the digital information.

8. The method of claim 7, wherein a presentation time of the presentation unit of the digital information recorded on the one or more mediums is managed by cell information, and the presentation management information includes one or more items of the cell information, said method further comprising:
recording, on the cell information, identification information of the medium on which the digital information corresponding to the cell information is recorded.

9. The method of claim 1, wherein one or more the information storage mediums correspond to one or more memory cards, the method further comprising:
acquiring each of items of presentation management information of the one or more memory cards;
preparing integrated presentation management information from the acquired items of the presentation management information; and
sequentially presenting cells of a program recorded on the memory cards according to descriptions of the integrated presentation management information, the cell representing a unit of presentation of the program.

10. The method of claim 1, wherein one or more the information storage mediums correspond to one or more memory cards, each of cells represents a unit of reproduction of a program to be recorded on the respective memory cards, and an order of reproduction of the cells is managed by presentation management information, the method further comprising:
preparing the presentation management information so that a same cell do not cover two or more the memory cards when a same program is recorded among or through a plurality of the memory cards.

11. The method of claim 1, wherein one or more the information storage mediums correspond to one or more memory cards each comprising a file management information recording area, a management information recording area, and an object recording area; a program of the digital information is recorded as an object file on the one or more memory cards; object management information including recording time information of an object corresponding to the recorded program is recorded at a leading portion of the object file recorded on the one or more memory cards; and a program chain information for managing a reproduction unit of the recorded program is recorded in the management information recording area which is recorded on the on the one or more memory cards, the method further comprising:
reading the object management information recorded at the leading portion of the object file, and the program chain information recorded in the management information recording area; and
reconstructing, when the recorded object is partly erased or moved, the program chain information for the program of which object is partly erased or moved, using the program chain information arranged older with respect to the recording time information of the object.

12. A digital information recording/reproducing apparatus wherein digital information recorded on one or more memory cards is managed according to a predetermined format, and each of the memory cards records identification information configured to specify the memory card and allocation information configured to indicate where is allocated a portion of the digital information, the apparatus comprising:
a connector module to which the one or more memory cards can be removably or detachably connected; and
a module configured to record and/or reproduce the digital information, comprising
an acquirer configured to acquire the allocation information of a particular one or ones of the one or more memory cards connected to the connector module and identified by the identification information, provided that a logical connection of the particular one or ones is established,
an integrator configured to integrate the acquired allocation information, and
a recorder/reproducer configured to record and/or reproduce the digital information using the one or more memory cards managed by the integrated allocation information.

13. The apparatus of claim 12, connectable to a controller which is configured to acquire allocation information of the one or more memory cards identified by the identification information, to integrate the acquired allocation information, and to exchange information with the one or more memory cards managed by the integrated allocation information, the apparatus further comprising:
one or more sockets configured to be removably or detachably connected with the one or more memory cards;
a processing module configured to record and/or reproduce the digital information using the one or more memory cards managed by the allocation information being integrated by the controller; and
a connection module configured to connect the processing module with the controller.

14. The apparatus of claim 12, wherein each of the memory cards is provided with a card-side antenna through which a radio-wave wireless information exchange as well as an electromagnetic-wave power supply are to be carried out, the apparatus further comprising:
a container cavity configured to contain the one or more memory cards;
an apparatus-side antenna configured to send an electromagnetic wave to each of the one or more memory cards in the container cavity, said electromagnetic wave having a power supply energy;
an acquirer module configured to acquire the allocation information of each of the one or more memory cards identified by the identification information, the one or more memory cards in the container cavity being power-supplied with the electromagnetic wave from the apparatus-side antenna, and a logical connection of the power-supplied one or more memory cards being established;
an integrator module configured to integrate the acquired allocation information; and
a processor module configured to record the digital information on the one or more memory cards or to reproduce the digital information from the one or more memory cards, the one or more memory cards being managed by the integrated allocation information.

15. The apparatus of claim 12, wherein each of the memory cards is provided with an optical element through which an optical information exchange is to be carried out, and each of the memory cards is provided with a solar cell configured to supply power, the apparatus further comprising:
a guide to which one of the one or more memory cards can be removably or detachably set; and
an optical transmitter/receiver module configured to transmit light to the optical element and the solar cell and configured to receive light from the optical element, the optical transmitter/receiver module being located at a light receiving side of the one or more memory cards arranged along the guide;
an acquirer module configured to acquire the allocation information of each of the one or more memory cards identified by the identification information, the one or more memory cards being operated with power supplied from the solar cell on which the light is irradiated, and a logical connection of the powered one or more memory cards being established via the optical element;
an integrator module configured to integrate the acquired allocation information; and
a recorder/reproducer module configured to record the digital information on the one or more memory cards or to reproduce the digital information from the one or more memory cards, the one or more memory cards being managed by the integrated allocation information.

16. The apparatus of claim 12, wherein the memory card comprises an antenna configured to carry out a radio-wave wireless information exchange and an electromagnetic-wave power supply.

17. The apparatus of claim 12, wherein the memory card comprises a photoelectric element configured to carry out information exchange by light, and a solar cell configured to supply electric power by light.
